(19) United States
(12) Patent Application Publication
(10) Pub. No.: US 2026/0228867 A1
(43) Pub. Date: Aug. 6, 2026

(54) METHODS AND APPARATUSES FOR FILM GRAIN ANALYSIS AND SYNTHESIS

(71) Applicant: InterDigital CE Patent Holdings, SAS, Paris (FR)

(72) Inventors: Claire-Helene Demarty, MONTREUIL LE GAST (FR); Zoubida Ameur, CESSON-SEVIGNE (FR); Olivier Le Meur, TALENSAC (FR); Daniel Ménard, DOMLOUP (FR); Edouard Francois, Bourg des Comptes (FR)

(21) Appl. No.: 19/151,222

(22) PCT Filed: Jan. 22, 2024
(86) PCT No.: PCT/EP2024/051419

§ 371 Date: Jul. 25, 2025

(30) Foreign Application Priority Data
Jan. 27, 2023 (EP) 23305106.9
Sep. 15, 2023 (EP) 23306526.7

(51) Int. Cl. G06T 5/77; G06T 5/60

(52) U.S. Cl. CPC G06T 5/77; G06T 5/60; G06T 2207/20084

(57) ABSTRACT

A method is disclosed that comprises obtaining (S800) an image. A film grain style vector representative of characteristics of film grain contained in the obtained image. The style vector is obtained (S802) by using a first neural network(S) with the obtained image as input, the first 5 neural network being a network trained to output a film grain style vector from an image.

### CROSS REFERENCE TO RELATED APPLICATIONS

This application claims the benefit of European Application No. 23305106.9, filed on Jan. 27, 2023, and of European Application No. 23306526.7, filed on Sep. 15, 2023 which are incorporated herein by reference in their entirety.

### TECHNICAL FIELD

At least one of the present embodiments generally relates to method and apparatuses for analyzing and synthetizing grainy images.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

Film grain is a specific type of noise that appears in video which is very pleasant and very distinctive. In its essence, film grain is a result of physical processes of analog film stock exposure and development. Originally the film grain is a noise due to the process of photography, more precisely a sensor noise, naturally present and unique for each analog camera. With the era of digital cameras, this sensor noise has disappeared at the capture stage but is now added afterwards to the content to recreate a movie look. The random nature of this noise makes it difficult to compress using traditional coding tools. The common parameters of the encoding tools, such as those chosen for low bit rates, often remove film grain. High bitrates are required to keep and reconstruct film grain with sufficient quality, which is contrary to the encoding/decoding goal of saving bits while encoding content. To overcome this encoder filtering issue, usually, film grain modeling is performed before the encoding stage and the film grain is added back to the reconstructed video using the model of the film grain, during a so-called synthesis step, at the decoding stage.

Adding film grain at the decoding stage, even for contents that did not originally contain film grain, can also help to mask artefacts or distortions that may appear in content, in particular because of the encoding/decoding process.

### SUMMARY

In one embodiment, a method is disclosed for analyzing film grain in an image. This method obtains a film grain style vector representative of characteristics of film grain contained in an image by using a first neural network, the first neural network being a network trained to output a film grain style vector from an image.

A method is disclosed for reconstructing a grainy image by using a second neural network with an obtained image and an obtained film grain style vector as inputs, the second neural network being a network trained to output a grainy image from a film grain style vector and an image.

In another example, a film-grain style vector is obtained by using another neural network with a latent code as input. The style vector may be used by another neural network configured to output a grainy image from an image.

A lightweight version of the different networks is also proposed.

### BRIEF DESCRIPTION OF THE DRAWINGS

FIG. 1 illustrates a block diagram of a system within which aspects of the present embodiments may be implemented;

FIG. 2 illustrates a block diagram of an embodiment of a video encoder;

FIG. 3 illustrates a block diagram of an embodiment of a video decoder;

FIG. 4 depicts a flowchart of a method of analysis and synthesis of film grain implemented in the context of Versatile Video Coding (VVC);

FIG. 5 illustrates the variation of a scaling factor according to an intensity level;

FIG. 6 illustrates a film grain model defined in a frequency domain for a given an intensity range;

FIG. 7 illustrates the variation of film grain standard deviation in function of an intensity;

FIG. 8A illustrates a block diagram of a system in which various aspects and embodiments can be implemented;

FIG. 8B depicts an architecture of a residual unit of a neural network;

FIG. 8C illustrates a block diagram of a system in which various aspects and embodiments can be implemented;

FIG. 9A depicts a flowchart of a method for analyzing film grain of an image according to an example;

FIG. 9B depicts a flowchart of a method for synthetizing film grain in an image according to an example;

FIG. 10A depicts a flowchart of an encoding method according to an example;

FIG. 10B depicts a flowchart of a decoding method according to an example;

FIG. 11A illustrates a block diagram of a system in which various aspects and embodiments can be implemented;

FIG. 11B illustrates a block diagram of a system in which various aspects and embodiments can be implemented;

FIG. 12 depicts a flowchart of a method for adding film grain to an image according to an example;

FIG. 13A illustrates a flowchart of a method to jointly learn neural network parameters;

FIG. 13B illustrates a flowchart of another method to jointly learn neural network parameters; and

FIG. 14 illustrates a flowchart of a complete cycle where a mapping network, a synthesis network and a style network are successively applied.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

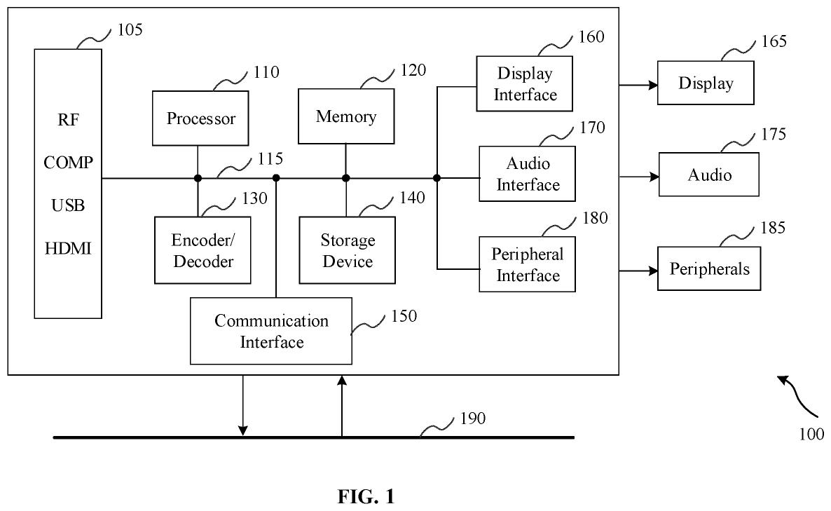

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC (Versatile Video Coding), ECM (Enhanced Compression Model) or HEVC (High Efficiency Video Coding), and can be applied, for example, to other standards and recommendations, whether pre-existing or future-developed, and extensions of any such standards and recommendations (including VVC, ECM and HEVC).

Unless indicated otherwise, or technically precluded, the aspects described in this application can be used individually or in combination.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side. In the following, the terms “grain” and “film grain” are used interchangeably.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

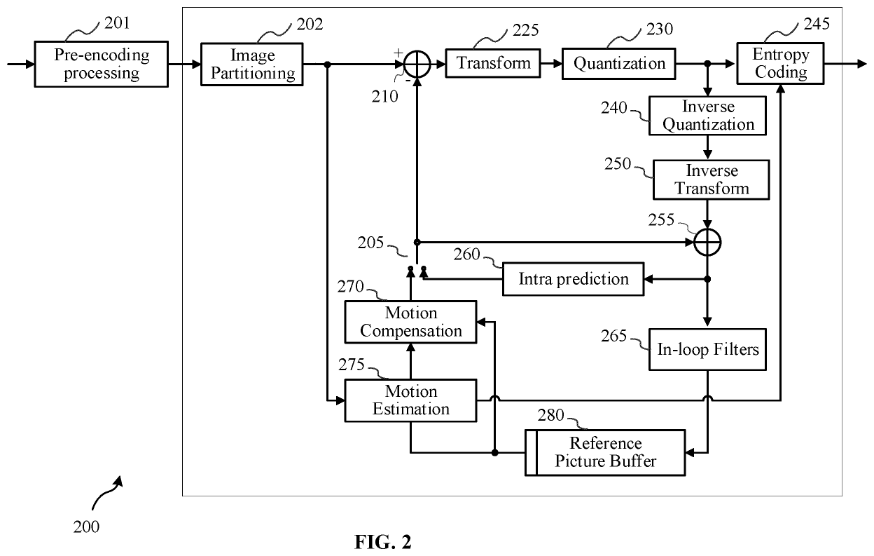

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260), e.g. using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). Video coding standards such as High Efficiency Video Coding (HEVC), Versatile Video Coding (VVC) and Enhanced Compression Model (ECM 6.0) support block transforms of different types, e.g. DCT (Discrete Cosine Transform) or DST (Discrete Sine Transform), which have been designed for square or rectangular blocks. These transforms are usually applied separably to blocks of prediction residuals obtained after intra or inter prediction.

The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes. In the case where, the input picture contains some film grain, the encoder quantization has the effect of removing the grain.

The encoder decodes an encoded block to provide a reference for further predictions. The quantized transform coefficients are de-quantized (240) and inverse transformed (250) to decode prediction residuals. By combining (255), e.g. adding, the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

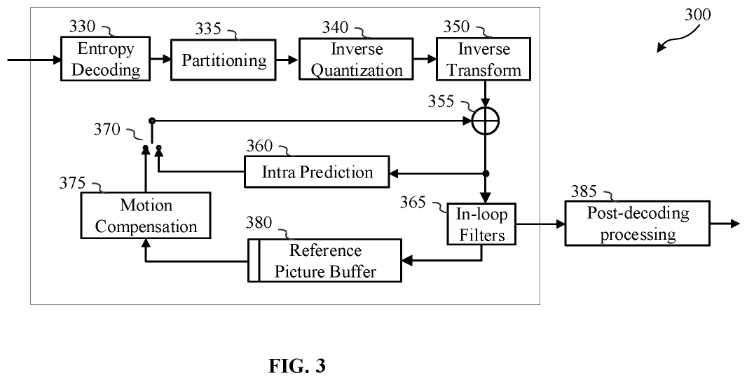

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2.

The encoder 200 also generally performs video decoding as part of encoding video data. In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355), e.g. adding, the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

### Film Grain Modeling

Film grain is often a desirable feature in video production, creating a natural appearance and contributing to the expression of creative intent. Film grain is a pleasant noise that enhances the natural appearance of video content. It was originally created during the physical process of exposure and development of photographic film. However, digital sensors do not undergo such processes and are therefore free of film grain. This generates noiseless digital video, whose perfection, clear and pronounced edges and monotonous regions can worsen the subjective experience of the viewer. Therefore, re-graining (i.e., adding film grain to) the video can improve visual experience and content creators often use it before distributing the content.

This is especially the case in the movie industry, where many creators turn to the technology of adding film grain to video content to add texture and warmth to their video, or sometimes create a sense of nostalgia (e.g., to describe a previous era if narrative calls for it). In addition, film grain can be used to mask compression artifacts even if it is not originally present in source video.

When added by content creators, film grain is adapted against different characteristics of the content, which are: intensity of the pixel values, presence and type of texture and saturation of the pixel values. They also select different grain patterns depending on the look they want to create. Additionally, the grain characteristics are adapted depending on the considered color component, resulting in a colored film grain. The addition of film grain is therefore a process that is content-dependent, pixel or region-dependent and which takes into account content intensity, texture and saturation characteristics as well as grain pattern characteristics.

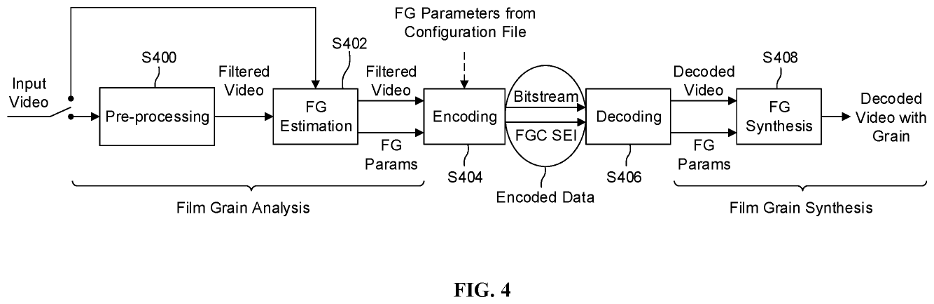

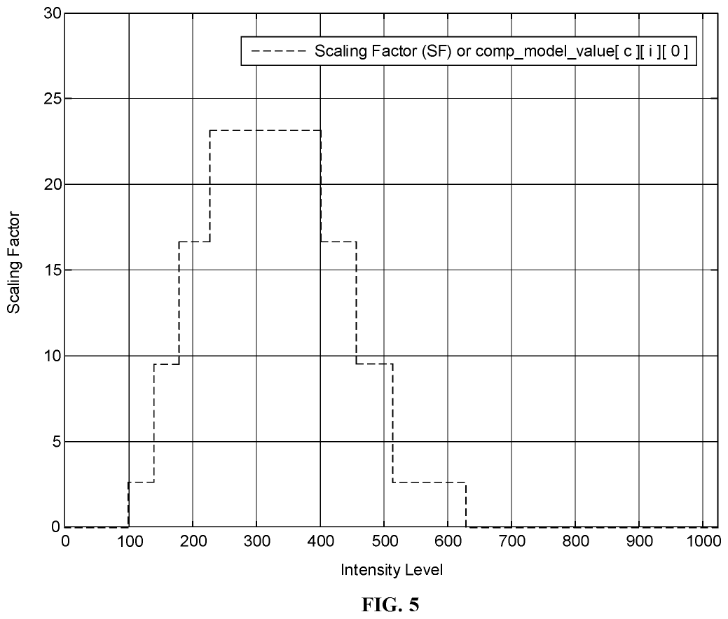

Since the introduction of Supplemental Enhancement Information for film grain in H264/AVC, film grain modeling becomes part of modern video coding standards. In particular, the analysis and synthesis of film grain is available in the compression standard Versatile Video Coding (VVC) also known as ITU-T H.266 and ISO/IEC 23090-3. In the context of video encoding/decoding, FIG. 4 depicts a flowchart of a method of analysis and synthesis of film grain implemented in the context of VVC. Information on film grain is communicated as metadata through for instance a SEI message (acronym of “Supplemental Enhancement Information”) specified by Versatile Supplemental Enhancement Information (VSEI, also known as ITU-T Recommendation H.274 and ISO/IEC 23002-7). The grain analysis takes as input an original frame with grain and a corresponding filtered frame without film grain. This filtered frame is first obtained at a step S400 via preprocessing (e.g., via a denoising step). From the filtered frame, uniform regions may then be then extracted as they will serve as mask to estimate in a step S402 the grain parameters in the grain layer, which is simply computed as the difference between the original frame and its filtered version. In the state-of-the-art versions of grain estimation, the extraction of uniform regions is important since edges and textures can affect the estimation of the film grain strength and pattern. The filtered video and the grain parameters (FG params on FIG. 4) are encoded in a step S404. In another embodiment, film grain parameters that are obtained from a configuration file may be encoded. In a variant, the film grain parameters are obtained directly by the decoder without being encoded, e.g., from a storage medium. These film grain parameters may be encoded for example in a case where the input image is grain free and thus in the case where the step S402 is bypassed. The encoding step outputs encoded data (e.g., in the form of a bitstream and a SEI message) that comprises the filtered video and the grain parameters as metadata. The encoded data are for example transmitted to a decoder. The decoding step S406 outputs the filtered video and the grain parameters. From the decoded data, i.e., the filtered video and the grain parameters, a decoded video with grain may be reconstructed at a step S408 wherein film grain is synthetized and added back to the filtered video. Common techniques used to insert noise/film grain consist in applying a pattern/noise, unique for each camera, in plain images, but with an intensity level that depends on the input signal. Different scaling factors are therefore applied to the film grain intensity depending on the intensity of the content as shown in FIG. 5. This film grain intensity level is, however, usually chosen constant for a given block in a given frame. Those blocks are uniform, i.e., they have the same size (e.g., 8×8).

Moreover, depending on the artistic look that is targeted, the film grain intensity is also made dependent on the texture present in the regions.

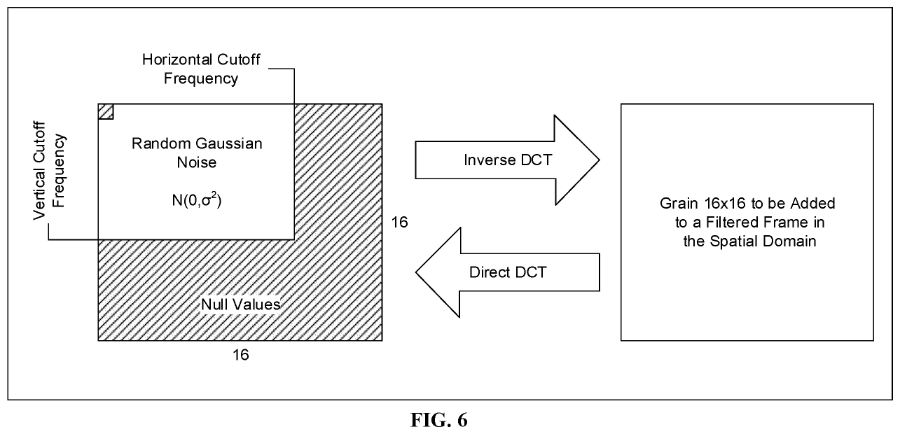

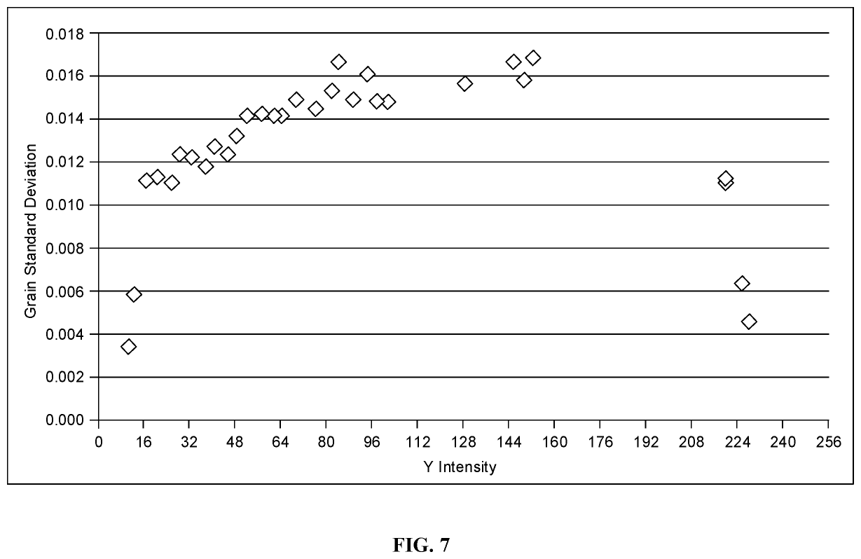

FIG. 6 depicts an example of a grain model defined in the DCT (acronym of Discrete Cosine Transform) domain of the luma layer, denoted Y layer. On FIG. 6, blocks of 16×16 pixels are considered. A 16×16 patch of grain in the Y spatial domain follows a model based on a random Gaussian distribution in the DCT domain and is applied only in a subpart of the 16×16 patch. The subpart of the patch is defined through vertical/horizontal cut-off frequencies also defined in the DCT domain. The 3 features that model the grain in the DCT domain are the variance σ² of the noise and the two cutoff frequencies that limit the area where the noise is present. The cutoff frequencies define the grain shape. If they are equal, the grain is circular. The DC component is set to a null value in order to obtain a centered patch grain in the spatial domain. The value of 02 depends on the mean Y value of the patch to which the grain has to be added, making the synthesis of film grain region-dependent. FIG. 7 shows an example of the grain variance evolution with respect to the intensity level in the filtered Y layer. Cutoff frequency values are supposed to be constant for a given shot.

In AV1 (AOMedia Video 1), the film grain pattern/template is modeled with an autoregressive process and its intensity is represented by a piecewise linear function that includes the grain strength for each Y, Cb and Cr component. The model is signaled into the encoded data, e.g., a SEI message. At a decoding step, the film grain model is decoded from the encoded data. In a re-noising step, i.e., the synthesis stage, a 64×64 luma film grain template is generated using the decoded film grain model. The film grain, a luma block of 32×32, extracted from the 64×64 film grain template, is applied on a 32×32 luma block basis after a piece-wise linear scaling, to reconstruct the picture with film grain. The film grain addition is applied on the full image. The block size is fixed and not dynamically adapted to the region.

Film grain generation methods are also proposed outside of the context of video compression. Such methods enable adding grain to a digital content without necessarily a prior analysis. In an example, a parametric model based on texture statistics may be used for film grain generation. Given a grain template image, the latter is decomposed into a steerable pyramid, i.e., a linear, multi-scale and multi-orientation image transform. Each scale and orientation of the pyramid is analyzed with respect to several statistical texture features including minimum and maximum gray values and correlation of sub-bands. The synthesis starts with random noise which ensures high spatio-temporal variations. The method produces synthetic grain which matches the template well while the random noise-based approach inherently provides realistic spatial and temporal variations. However, the resulting synthesis is not content-adapted and is therefore uniform on any image, whatever the underlying image characteristics, e.g., structures and textures.

In another example, a stochastic model can be used to approximate the physical reality of film grain. To model the film grain, a boolean inhomogeneous model is used to mimic the analog photographic process as closely as possible. The model corresponds to uniformly distributed disks using a Poisson process of variable intensity which determines the amount of grain with respect to the local image gray level. The grain rendering method is modeled with a single Gaussian kernel using a Monte Carlo simulation which performs simultaneous filtering and discretization of the film grain model. A wide range of grain sizes and intensities can be generated by varying the parameters of this model, among which are the average grain radius and its standard deviation. Some bigger values of these parameters accentuate the grain of the rendered result.

In yet another example, a deep-learning based method, called deep1 in the following, is used where the film grain synthesis task is considered as a translation of a given grain-free input image into a corresponding grainy output image. As an example, a U-Net with residual blocks may be used for the grain generation where the U-Net is trained with a discriminator in a conditional GAN (generative adversarial network) framework. The synthesis model is conditioned on both the input image and some expected grain intensity level, which allows the synthesis to be content-dependent with a controllable intensity level.

The above-mentioned film grain generation methods make it possible to generate only a limited set of grain types that only vary in size and intensity. Therefore, these methods do not provide a diversity in the generated grain types. More generally, the methods for both estimating the film grain parameters and then synthesizing/generating a film grain in an encoding/decoding context are limited in terms of variety of the film grain characteristics they can estimate and then re-synthesize in the content. Indeed, as implemented in VVC or AV1, during the analysis step, the texture and color saturation characteristics of the content are not modeled. Moreover, one single grain pattern is considered and only some variations on the size of this pattern are considered. Furthermore, only uniform regions are considered during the estimation, but grain is also present in non-uniform regions and with different characteristics.

During the synthesis step, film grain is usually applied per block on the input content, with variations in terms of intensity that depend only on the intensity level of each block. In some examples, texture can also be taken into account through some information from the encoding/decoding process such as the size of the encoded blocks, as it is driven by the level of texture in each region. In AV1, the block size is fixed, i.e., there is no partitioning of a frame into blocks of different sizes depending on the underlying texture of the frame. Consequently, in AV1 the texture is not considered during the synthesis step. In conclusion, the fidelity to an original film grain is not always respected. Moreover, diversity of the generated film grains is limited.

The deep1 method makes it possible to generate a more precise and diverse film grain, thanks to a learning process capable of automatically grabbing more characteristics of the film grain. However, the informative description of the film grain characteristics is contained in the models themselves, which means that no parameter representative of the film grain is available. Said otherwise, there is no compact representation of the film grain. One needs to have the weights of the learned model to generate the film grain. Furthermore, both learned models are driven by a film grain level map to set the expected level of intensity which is also limiting the diversity of the outputs. The diversity of the learned grain is therefore not representative of the diversity of grain styles that may be generated by content creators. The style may be referred to as the appearance of the film grain.

In the following embodiments, film grain generation and synthesis are thus improved by providing a complete, compact, and flexible representation of the film grain present in a content, as generated by content creators. Such a representation enables the synthesis of film grain, which respects the fidelity to some original ground truth film grain if available, and which also offers a large diversity of film grains, representative of the diversity of film grains generated by content creators.

A proposed method makes it possible to extract and model film grain characteristics (intensity and pattern of grain, dependent on content in intensity, texture, saturation, etc.) from a grainy image, these characteristics being summarized in the form of a film grain style vector. A grainy image is an image containing film grain. In the following, the terms “film grain style vector” and “style vector” are used interchangeably. The film grain style vector thus represents all the style information of a given film grain. The style vector may be used to synthesize film grain so that fidelity to the original film grain (if any) is respected. Fidelity to the original film grain is respected in the case where the synthetized film grain is perceptually similar to the original film grain. In addition, the style vector makes it possible to generate a large diversity of film grain types. The style vector may also be encoded into encoded data (e.g. in a bitstream as side information). Said otherwise, one of the proposed methods makes it possible to generate some film grain styles that are perceptually similar and as diverse as what content creator artists manually generate. More precisely, the method respects fidelity to some existing grainy reference if any. In addition, the method makes it possible to represent in a compact way, a large variety of the grain styles, that may be easily transmitted in a video compression use case.

To this aim, deep-learning based methods are used. The deep-learning based methods use neural networks that are learned through a joint learning. The methods use a style vector to model film grain characteristics, style vector being a complete, flexible and compact representation of these characteristics. Such a style vector is constructed either from a reference frame containing some grain thanks to a style encoder (also called style neural network or style network), or from a random latent code thanks to a mapping network in the case where no reference grainy image is available. Then, from this style vector, the synthesis of film grain on any content is conducted through a synthesis network, that respects fidelity to some ground-truth film grain, when it exists. In case no ground truth, i.e., no reference, is available, it enables to produce a large diversity of grain styles, in a random manner. For the case with ground truth, it improves the fidelity of the actual film grain synthesis process in the encoding/decoding chain. Said otherwise, the synthesized film grain is perceptually close to the original film grain (also called ground truth film grain). For the case with no ground truth, it enables to generate diverse film grains that will enlarge the capability to mask artifacts, e.g., those generated from some encoding/decoding process. Fidelity to a ground-truth film grain and diversity of the grain styles are obtained by using specific loss functions in the learning stage (also called training stage) of the neural networks.

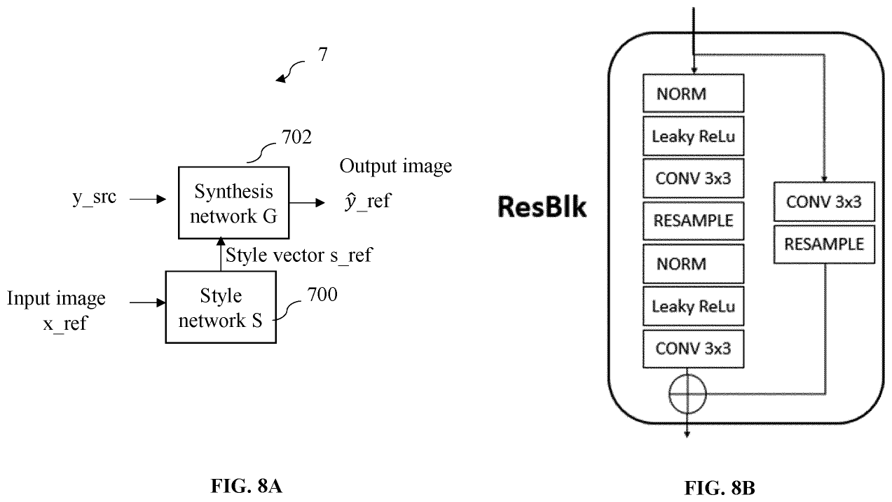

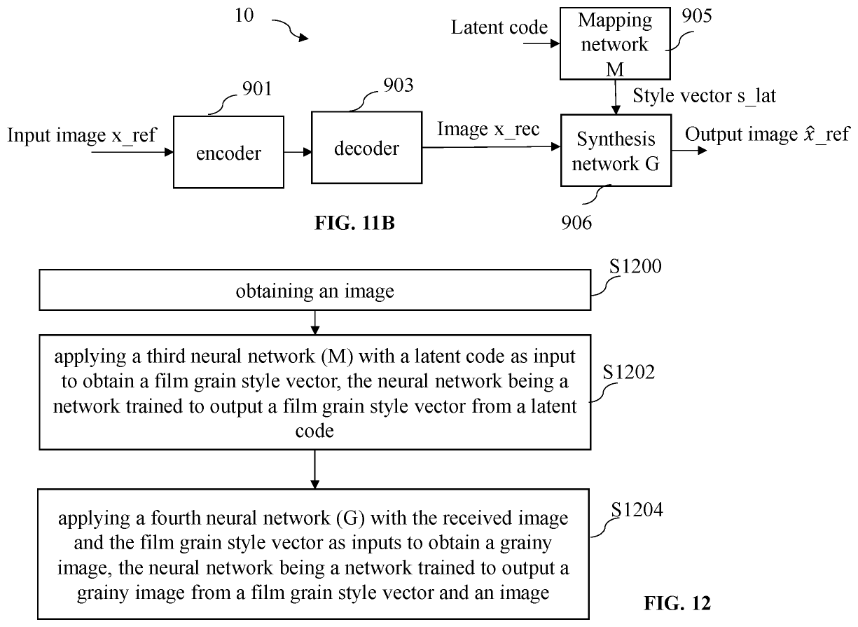

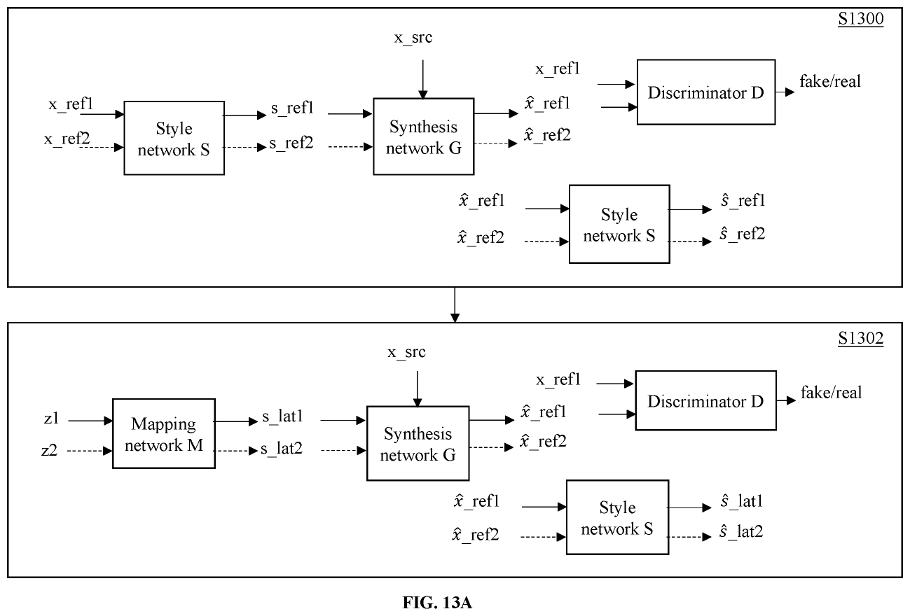

Indeed, the parameters of the neural networks are first learned. Said otherwise, the neural networks are trained to learn their parameters. Once the parameters of the neural networks are learned, the networks may be effectively used for film grain estimation and synthesis as depicted on FIGS. 8A to 10 or for film grain synthesis as depicted on FIGS. 11-12. Inference refers to the effective usage of the neural networks defined by the learned parameters. Said otherwise, inference applies a trained neural network and uses it to infer a result. Inference comes after training as it requires a trained neural network.

FIG. 8A illustrates a block diagram of a system 7 in which various aspects and embodiments can be implemented. This example may be referred to as a reference-guided synthesis since an image (e.g., a grainy image) is used as a reference. Indeed, the synthesized grain is expected to be similar to the one present in this input image.

The system 7 comprises a trained style network S (700) and a trained synthesis network G (702).

In operation, the trained style network S (700), also called style encoder S, receives an input image x_ref and outputs a style vector s_ref. Given an input grainy image x_ref, the style encoder S first extracts the grain properties in the form of a style vector s_ref: s_ref=S(x_ref).

The style vector s_ref thus represents faithfully the film grain properties such as the grain pattern and its size, randomness, intensity, color, etc. Such properties may also include how film grain is adaptive to the original content, e.g., to content properties such as its intensity, saturation, texture, etc. Hence, the use of a vector as a generic representation that is inferred directly from a grainy frame is particularly well designed for the task. A vector will also be easier to encode and transmit compared to a map or compared to the weights of a network in the context of video compression and transmission. The style network's architecture is based on a convolutional neural network (CNN) with residual blocks and a final fully connected layer, e.g., with an output dimension of 64, which is the dimension of the style vector. In a particular example mentioned in Table 1, the style network S may comprise a first 1×1 convolution layer, 6 residual units whose architecture is depicted on FIG. 8B, followed by a Leaky ReLu layer, a 4×4 kernel convolution layer, another Leaky ReLu and finally a fully connected layer of size 64. The style network S may take as input an image with grain x_ref (e.g., of size 256×256×3) and output a style vector of dimension s_ref (e.g., of dimension 64)

TABLE 1

| LAYER | RESAMPLE | NORM | OUTPUT SHAPE |
|---|---|---|---|
| Image x | — | — | 256 × 256 × 3 |
| Conv1 × 1 | — | — | 256 × 256 × 64 |
| ResBlk | AvgPool | — | 128 × 128 × 128 |
| ResBlk | AvgPool | — | 64 × 64 × 256 |
| ResBlk | AvgPool | — | 32 × 32 × 512 |
| ResBlk | AvgPool | — | 16 × 16 × 512 |
| ResBlk | AvgPool | — | 8 × 8 × 512 |
| ResBlk | AvgPool | — | 4 × 4 × 512 |
| LReLU | — | — | 4 × 4 × 512 |
| Conv4 × 4 | — | — | 1 × 1 × 512 |
| LReLU | — | — | 1 X 1 × 512 |
| Reshape | — | — | 512 |
| Linear | — | — | 64 |

Therefore, from a grainy image of size 256×256×3, this style network S is able to derive a film grain style vector of size 64. As depicted on FIG. 8B, the residual unit architecture may comprise a normalization layer, a Leaky ReLu layer, a convolutional layer with a kernel 3×3, a resampling layer, another normalization layer, followed by a second Leaky ReLu layer and a second convolutional layer, e.g., with a kernel 3×3. In parallel, a residual connection, composed of a convolutional layer (e.g., with a kernel 3×3) and a resampling layer, may be set between the input and the output. In other examples, the dimensions of the input grainy image/output style network and the architecture of the network may vary.

The specificity of this film grain analysis/modeling module is the nature of the inputs/outputs. Indeed, it takes as input a grainy image (instead of a pair of grainy and filtered images in the state-of-the-art) and it outputs a film grain style vector (instead of a limited set of distinct parameters).

In an example, the style vector is conditioned to contain spatially organized information, i.e., the first n bits are related to the grain pattern, the next m bits are related to the grain size, etc, where n and m are positive integers.

Thanks to the style encoder S, filtering and edge detection steps performed in some grain analysis methods may be bypassed. The style encoder S is configured to extract the grain properties as a style vector exclusively from a grainy image (no prior filtering needed). The output style vector may be used later by a synthesis network G to reconstruct the grain with maximum fidelity to the original one, e.g., from a grain-free image given as input. From an input image y_src and the style vector, the synthesis network G (702) is capable of generating a film grain in the form of a grain map, which enables to reconstruct an output image ŷ__ref as the addition of the input image y_src and the film grain map generated from the style vector. In a variant example instead of adding the grain map, the grain map whose values are in the range zero-one, is multiplied pixel-wise to the input image y_src.

The synthesis network (or generator) G is based on an encoder-decoder architecture with residual blocks where the style vector is injected into all the up-sampling blocks using the AdaIN which is a normalization method that aligns the mean and variance of the content features with those of the style features. In a particular example mentioned in Table 2, the synthesis network (or generator) G may comprise a first convolutional layer (e.g., with a kernel 1×1), followed by (e.g., four) downsampling blocks, (e.g., four) intermediate blocks, and (e.g., four) upsampling blocks, e.g., all of which inherit pre-activation residual units (ResBlk), and e.g., a last 1×1 convolutional layer.

The residual unit architecture is described by FIG. 8B. The normalization (NORM) and resampling (RESAMPLE) layers are different depending on whether the ResBlk is in a downsampling block, an intermediate block or an upsampling block. For downsampling blocks, resampling layers correspond to average pooling 2D layers. For upsampling blocks, they consist of classic upsampling layers through interpolation. For the normalization layers, instance normalization is used in the downsampling blocks and the first two intermediate blocks, whereas adaptive instance normalization is used in the last two intermediate blocks and the upsampling blocks. The synthesis network G may take as input an image without grain x_src (e.g., of size 256×256×3) and a style vector s (e.g, of dimension 64). It may output an image with grain x_ref (e.g., of size 256×256×3).

TABLE 2

| LAYER | RESAMPLE | NORM | OUTPUT SHAPE |
|---|---|---|---|
| Image x | — | — | 256 × 256 × 3 |
| Conv1 × 1 | — | — | 256 × 256 × 64 |
| ResBlk | AvgPool | IN | 128 × 128 × 128 |
| ResBlk | AvgPool | IN | 64 × 64 × 256 |
| ResBlk | AvgPool | IN | 32 × 32 × 512 |
| ResBlk | AvgPool | IN | 16 × 16 × 512 |
| ResBlk | — | IN | 16 × 16 × 512 |
| ResBlk | — | IN | 16 × 16 × 512 |
| ResBlk | — | AdaIN | 16 × 16 × 512 |
| ResBlk | — | AdaIN | 16 × 16 × 512 |
| ResBlk | Upsample | AdaIN | 32 × 32 × 512 |
| ResBlk | Upsample | AdaIN | 64 × 64 × 256 |
| ResBlk | Upsample | AdaIN | 128 × 128 × 128 |
| ResBlk | Upsample | AdaIN | 256 × 256 × 64 |
| Conv1 × 1 | — | — | 256 × 256 × 3 |

In another embodiment, the synthesis network may output the grain map (of size 256×256×3) to be further applied on x_src to generate the image with grain \hat{x}_ref.

In another embodiment, the synthesis network may output both an image with grain \hat{x}_ref (e.g., of size 256×256×3) and its grain map (e.g., of size 256×256×3). In this case, the last convolutional layer of the network outputs the grain map with a dimension of 256×256×3, which is added to x_src to output \hat{x}_ref with a dimension of 256×256×3.

The synthesis network G generates a specific grain style corresponding to the style vector, and blends it to the input image y_{src}: ŷ_{ref}=G(y_{src}, s_{ref}) with ŷ_{ref} containing perceptually similar grain to x_{ref}.

The style vector produced by the style encoder is content-independent. Indeed, the synthesis network G is responsible for adapting and scaling the grain style according to the underlying content of the input y_{src}.

FIG. 8C illustrates a block diagram of a system 8 in which various aspects and embodiments can be implemented. This example may also be referred to as a reference-guided synthesis since an image (e.g., a grainy image) is used as a reference. Indeed, the synthesized grain is expected to be similar to the one present in this input image. The system 8 comprises an encoder (800), a trained style network S (802), a decoder (804) and a trained synthesis network G (806). The trained style network S (802) and the synthesis network G (806) may be identical to respectively the trained style network S (700) and the synthesis network G (702). In operation, the encoder (800), e.g., the one disclosed with reference to FIG. 2, receives a grainy image x_ref on one of its inputs. This grainy image may be of type YUV. In an example, the grainy image is converted to an RGB image before serving as input to the style encoder.

This conversion step is optional. In another example, the color space of this input grainy image after or before conversion can be replaced by another color space such as Lab, HSV. In another embodiment, only the Y component of the grainy image is transmitted as input to the style encoder. The encoder encodes the image into encoded data, e.g., into a bitstream. The trained style network S (802), also called style encoder S, receives the input image x_ref (possibly after color conversion) and outputs a style vector s_ref. Given an input grainy image x_ref, that corresponds to a grain-free image x_src, the style encoder S first extracts the grain properties in the form of a style vector s_ref: s_ref=S(x_ref).

The style vector s_ref is then encoded by the encoder (800). For instance, the style vector may be encoded in a SEI message (SEI stands for “Supplemental Enhancement Information”) added to the bitstream comprising the encoded image. This encoded data (the image and its associated style vector) may then be transmitted to the decoder (804), e.g., the decoder of FIG. 3. The decoder may reconstruct the encoded image and further the style vector. From the reconstructed image x_rec and the style vector, the synthesis network G (806) is capable of generating a film grain in the form of a grain map, which enables to reconstruct an output image as the addition of the decoded image x_rec and the film grain map generated from the style vector. In a variant example instead of adding the grain map, the grain map whose values are in the range zero-one, is multiplied pixel-wise to the decoded image.

The synthesis network G generates a specific grain style corresponding to the style vector, and blends it to the input image x_{src}: \hat{x}_{ref}=G(x_{rec}, s_{ref}) with \hat{x}_{ref} containing perceptually similar grain to x_{ref}.

The style vector produced by the style encoder is content-independent. Indeed, the synthesis network G is responsible for adapting and scaling the grain style according to the underlying content of the input.

In the examples disclosed below some optional color conversion of the images may take place before the style network S, before the encoder and/or after the decoder to match the color space needed as input to the style network S, the encoder, and/or the synthesis network G.

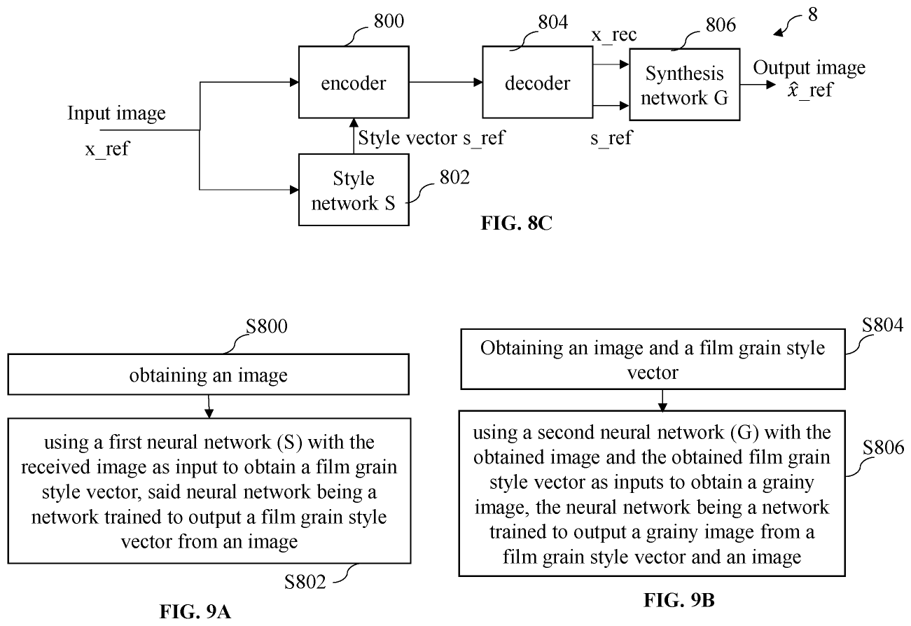

FIG. 9 A depicts a flowchart of a method for analyzing film grain of an image according to an example.

At a step S800, an image is obtained. The image may be obtained from a storage medium or from a network.

At a step S802, a film grain style vector is obtained by using a first neural network, namely the style network S, with the obtained image as input. The film grain style vector is representative of characteristics of film grain contained in the obtained image. The first neural network is a network trained to output a film grain style vector from an image.

FIG. 9B depicts a flowchart of a method for synthetizing film grain in an image according to an example.

At a step S804, an image and a film grain style vector are obtained, e.g., from a storage medium or from a network.

At a step S806, a grainy image is obtained by using a second neural network, namely the synthesis network G, with the obtained image and the obtained film grain style vector as inputs, the second neural network being a network trained to output a grainy image from a film grain style vector and an image.

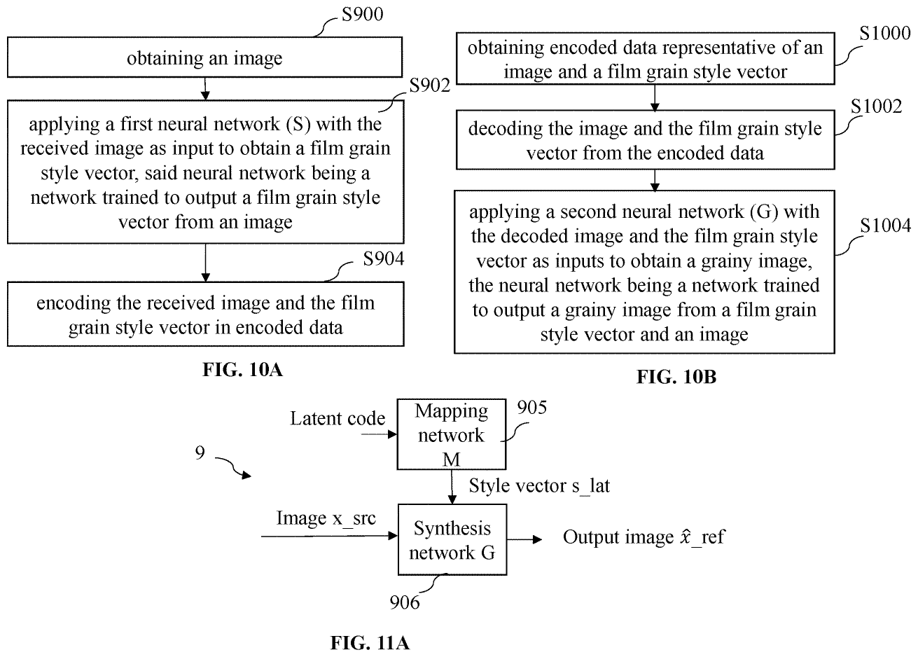

FIG. 10A depicts a flowchart of an encoding method according to an example.

At a step S900, an image is obtained, e.g., an RGB or a YUV image. The image may be obtained from a storage medium or from a network.

At a step S902, a film grain style vector is obtained by using the first neural network, namely the style network S, with the received image as input. The film grain style vector is representative of characteristics of film grain contained in the obtained image. The first neural network is a network trained to output a film grain style vector from an image. At a step S904, the obtained image and the film grain style vector are encoded in encoded data.

FIG. 10B depicts a flowchart of a decoding method according to an example.

At a step S1000, encoded data representative of an image and a film grain style vector are obtained, the film grain style vector representative of characteristics of film grain. The encoded data may be obtained from a storage medium or transmitted from an encoder through a wired or wireless network.

At a step S1002, the image and the film grain style vector are decoded from the encoded data. At a step S1004, a grainy image is obtained by using the second neural network, namely the synthesis network G, with the decoded image and the film grain style vector as inputs, the second neural network being a network trained to output a grainy image from a film grain style vector and an image.

FIG. 11A illustrates a block diagram of a system 9 in which various aspects and embodiments can be implemented. This example may be referred to as a latent-guided synthesis since no reference is available.

The system 9 comprises a trained mapping network M (905) and a trained synthesis network G (906), which may be the same as in the systems 7 and 8. The mapping network M is configured to generate a style vector s_lat based on a random latent vector, also called latent code, as input. More precisely, the mapping network is configured to transform a random vector (also called latent code) sampled from a Gaussian distribution into a style vector in order to generate diverse grain types. The style vector s_lat is in turn used as input to the synthesis network G to generate grain on an input image, e.g., on a grain-free image. When no reference grainy image is available, a set of style vectors may be defined and stored in a database and further used for film grain generation. However, the diversity of the film grain types would be limited to the stored vectors. On the contrary, through the use of the mapping network more diversity in the grain style is generated.

In operation, the synthesis network G (906) is capable of reconstructing an output image \hat{x}_ref from an input image x_src and a style vector s_lat, wherein \hat{x}_ref is the input image x_src to which film grain generated using the style vector s_lat is added. In an example, the image x_src is an RGB image. In another embodiment, the color space of this input image can be replaced by another color space such as Lab, YUV, HSV.

As in the systems 7 and 8, the style vector s_lat produced by the mapping network M (905) is content-independent. Indeed, the synthesis network G is responsible for adapting and scaling the grain style according to the underlying content of the input.

From the input image x_src and the style vector s_lat, the synthesis network G (906) is capable of generating a film grain in the form of a grain map, which enables to reconstruct an output image as the addition of the input image and the film grain map generated from the style vector.

In a variant example instead of adding the grain map, the grain map whose values are in the range zero-one, is multiplied pixel-wise to the decoded image.

In the system 9, no reference grainy image is used; instead, the mapping network M transforms a random latent code z from a standard Gaussian distribution Z into a style vector s_lat: s_lat=M (z). The mapping network M may be based on a Multi Layer Perceptron (MLP) and may take as input a latent code (e.g., of dimension 16) randomly sampled, e.g., from a standard Gaussian distribution. In a particular example, the mapping network M may be a Multi Layer Perceptron (MLP) of (e.g., eight) fully connected layers (e.g., of dimension 512). The dimensions of the latent code, the hidden layers, and the style code may be for example set to 16, 512, and 64, respectively. In this case the mapping network M outputs a style vector s_lat of dimension 64. As film grain is a random noise that does not necessarily follow a Gaussian distribution, the mapping network enables to map a latent code sampled from a Gaussian distribution to a style vector to generate a more precise and diverse grain style. The mapping network therefore learns the distribution and diversity of the film grain present in the training dataset. Thanks to a joint learning, it also learns to output style vectors that are close to the ones output by the style network S of the system 8. In another example, latent codes z could be taken from a non-standard gaussian distribution.

In yet another example, the input and output dimensions of the mapping network as well as its architecture may vary. However, the output dimension should match the output dimension of the style encoder and the dimension of the style vector that serves as input to the generator.

FIG. 11B illustrates a block diagram of a system 10 in which various aspects and embodiments can be implemented. This example may also be referred to as a latent-guided synthesis since no reference is available. The system 10 is a variant of the system 9 in which the image used as input by the trained synthesis network G (906) is an image reconstructed by a decoder (903). The system 10 thus comprises an encoder (901) and a decoder (903).

In operation, the synthesis network G (906) is capable of reconstructing an output image \hat{x}_ref from an input image x_rec and a style vector s_lat, wherein \hat{x}_ref is the input image x_rec to which film grain generated using the style vector s_lat is added. In an example, the image x_rec is an RGB image. In another embodiment, the color space of this input image can be replaced by another color space such as Lab, YUV, HSV. The input image x_rec is obtained by the decoder (903), e.g., the decoder of FIG. 3 configured to decode received encoded data and reconstruct an image therefrom. The received encoded data may be obtained by the encoder (901), e.g., the one disclosed with reference to FIG. 2. The encoder (901) is configured to receive an image on one of its input x_ref and to encode the image into encoded data, e.g., into a bitstream.

As in the systems 7 to 9, the style vector s_lat produced by the mapping network M (905) is content-independent. Indeed, the synthesis network G is responsible for adapting and scaling the grain style according to the underlying content of the input.

From the input image and the style vector s_lat, the synthesis network G (906) is capable of generating a film grain in the form of a grain map, which enables to reconstruct an output image as the addition of the input image and the film grain map generated from the style vector. In a variant example instead of adding the grain map, the grain map whose values are in the range zero-one, is multiplied pixel-wise to the decoded image.

FIG. 12 depicts a flowchart of a method for adding film grain to an image according to an example.

At a step S1200, an image is obtained, e.g., a RGB or a YUV image. The image may be obtained from a storage medium or from a network. In a specific example, the image is an image decoded by a decoder from encoded data. The decoded image may be optionally converted to match the color space needed as input to the synthesis network G.

At a step S1202, a film grain style vector representative of characteristics of a film grain is obtained by using a third neural network, namely the mapping network M, with a latent code as input, the third neural network being a network trained to output a film grain style vector from a latent code.

At a step S1204, a grainy image is obtained by using a fourth neural network, namely the synthesis network G, on the received image and the film grain style vector, the fourth neural network being a network trained to output a grainy image from a film grain style vector and an image. The fourth neural network is the same as the second neural network.

The neural network parameters (e.g., weights and bias) of the style, mapping and synthesis neural networks S, M and G used by the systems 8 and 9 are estimated during a training (also called learning) stage.

To this aim, the neural networks S, M and G are trained on a massive dataset of images (i.e., the neural network parameters are learned). In an example, a dataset of 148 694 grain free images is used. The dataset also comprises for each grain free image, 5 different grainy versions. Classically, the learning stage comprises a forward pass and a backward pass. The forward pass designates the flow direction from “input” to “output”. The backward pass designates the flow direction from “output” to “input” during which gradients of a loss function are propagated backwards. The aim of the backward pass is to distribute the total error back to the network so as to update the parameters in order to minimize a cost function (the loss function). The updates are determined by the gradients of the cost function with respect to those parameters. The parameters are updated in such a way that when the next forward pass utilizes the updated parameters, the total error is reduced by a certain margin (until the minima is reached).

During the learning stage of the neural networks S, M and G, an additional neural network, namely a discriminator D, is used to adversarially train the synthesis network G. In an example, the discriminator may be based on a PatchGAN architecture with a e.g., 30×30 receptive field. PatchGAN takes as input an image and classifies whether each e.g., 70×70 patch in the image is fake or real instead of providing a single probability for the entire input image. Since film grain synthesis is a subjective task, no straightforward objective loss function can be defined to be minimized by the synthesis network during training. Consequently, all four networks are trained in a cGAN framework conditioned on the style vector for film grain synthesis and generation. More precisely, all four networks S, M, G and D are trained jointly in two successive forward steps: a first reference-guided forward step, followed by a latent-guided forward step, each followed by a backward step. This joint-learning ensures both a fidelity to the original grain in the reference-guided synthesis and the diversity in the realistic grain styles generated in the latent-guided synthesis.

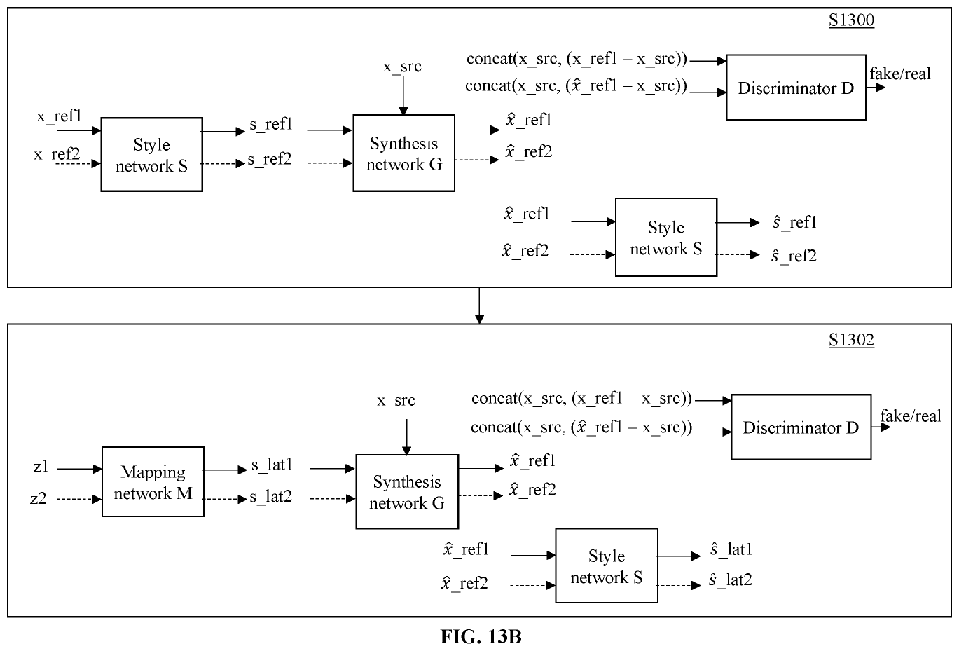

FIG. 13A illustrates a flowchart of a method to jointly learn the neural network parameters. To this aim, a large and diverse film grain dataset is used that is called FilmGrainStyle740k Dataset in the following. The dataset is composed of groups of images, containing one image without grain and up to five corresponding images with five different types of film grain. This dataset is representative of the artistic intent of content creators. Such groups of corresponding grainy and grain-free images will allow to drive the reference-guided synthesis. This dataset is generated from 148K (K stands for thousands) original clean images, also called grain-free images, from different and diverse image datasets, including 400 images from Berkeley segmentation dataset (BSD), 4744 images from Waterloo Exploration Database, 900 images from DIV2K dataset, 2650 images from Flick2K dataset and 140 000 images from the Konstanz artificially distorted image quality set (KADIS-700k). Five different types of film grain representative of different types of cameras are considered, resulting in different grain patterns. Images with grain are generated from 148 694 original images to adjust the grain patterns to the underlying content according to three attributes: intensity, texture and saturation. By varying the parameters according to Table 3 below, 240 different grain combinations/styles are generated in total.

TABLE 3
Number of values per parameter for each grain/content characteristic
and total number of resulting combinations.

| Pattern | Intensity | Saturation | Texture | Total |
|---|---|---|---|---|
| 5 | 6 | 4 | 2 | 240 |

For each grain-free image, 5 grainy versions are produced such that all 240 grain styles are represented in an equitable manner in the dataset. In total, the dataset contains 740K grainy images.

In an example, Adam optimizer with 1=0 and 82=0.99 is used to train the neural networks by optimizing the loss functions described below. The batch size is set to 4 with 50K training iterations. Weights of all networks are initialized using for example an He initialization. Learning rates are important hyper-parameters as, besides the instability of training GANs, training four modules jointly arise additional challenges. The learning rates are therefore chosen to both balance the learning of each network against the others and to ensure stability in the learning process between the synthesizer and discriminator. In an example, they are fixed to: 3e-4 for G, 5e-5 for S, 5e-5 for D and 1e-4 for M. The synthesis network G count 33M parameters (M stands for million), the style network 20M, the mapping network 2M and the discriminator 3M. To train the models, two grainy images (x_ref1, x_ref2) are selected for each grain-free image x_src. The training, validation and test sets respectively consist in 146K, 480 and 960 grain-free images, randomly selected from the dataset.

The learning method comprises two successive forward steps, each being followed by a backward pass to update neural network parameters.

In a step S1300, the parameters of the networks G and D are updated by minimizing the following first global loss function: [symbol] = [symbol] + [symbol] + [symbol] + [symbol] +λ_{VGG} [symbol] In a variant, the first global loss function is defined as [symbol] = [symbol] + [symbol] + [symbol] + [symbol] or

$${ℒ}_{{total}_{ref}} = {ℒ}_{adv} + {ℒ}_{{sty}_{ref}} + {ℒ}_{{div}_{ref}} + {λ}_{VGG} {ℒ}_{VGG}$$

In an example, [symbol] is computed with both x_ref1 and x_ref2, the other elementary loss functions being computed with x_ref1 only. Therefore, in a first forward pass, the style network S, the networks G and D are used with a triplet of images (x_src, x_ref1, x_ref2) as input to generate outputs from which a loss value may be computed. The triplet of images comprises a grain free image x_src, a first grainy version x_ref1 of the grain free image and a second grainy version x_ref2 of the grain free image. In the following backward pass, the parameters of the networks G and D are updated. In a variant, the parameters of the networks S, G and D are updated during the first backward pass. In other examples, any combinations of updates of the network parameters may be done, e.g., S and D, or S and G, or updating S twice and G, etc.

In a step S1302, the parameters of the network S, M, G and D are updated by minimizing the following second global loss function: [symbol] = [symbol] + [symbol] +

[symbol]

In an example, [symbol] is computed with both z1 and z2, the other elementary loss functions being computed with z1 only. Therefore, in a second forward pass, the style network S, the mapping network M, the networks G and D are applied with the triplet (x_src, z1, z2) as input to generate outputs from which a loss value may be computed. The latent codes z1 and z2 are randomly sampled, for example from a standard Gaussian distribution. In the following backward pass, the parameters of all four networks are updated. In another variant, only some networks may be updated, e.g., those not updated during the first forward pass. The networks may be updated once, twice, etc. Any other combinations of updates of the network parameters may be done.

The steps S1300 and S1302 may be repeated with each set of (x_src, x_ref1, x_ref2, z1, z2), with (x_src, x_ref1, x_ref2) that may be derived from the dataset and (z1, z2) that may be randomly sampled, from for example a standard Gaussian distribution.

The learning may be done with input images in RGB, YUV or any other color space. In another example, the style network is trained on one color component, e.g. the Y component of the input image only, while the synthesis network G is trained to generate grain in the full colored image.

In another example, the learning stage comprises only the first forward step. In this case, only the networks S, G and D are trained for being used in an inference stage.

In another example, the learning stage comprises only the second forward pass step without the style encoder S. In this case, only the networks M, G and D are trained for being used in an inference stage.

Examples of various loss functions mentioned above are further defined below.

### Adversarial Objective

The synthesis network G learns to generate a synthesized grainy image G(x_{src}, s) via the following adversarial loss:

$${ℒ}_{adv} = {E}_{{x}_{ref}} [ log ( D ( {x}_{ref} ) ] + {E}_{{x}_{srcs}} [ log ( 1 - D ( G ( {x}_{src} , s ) ) ) ]$$

By classifying the outputs of the synthesis network as real or fake, the discriminator encourages it to output images containing perceptually real-like grain. However, it does not enforce any diversity of the generated grain, nor its fidelity to some specific reference. These constraints are addressed in the following style (fidelity) and diversity objectives.

### Style Objective

To force the synthesis network G to utilize the style vector s when generating grainy images, a style reconstruction loss is used. The latter ensures that the style vector S(\hat{x}_{ref}) corresponding to the generated image is close to the style vector used to generate it. In the reference-guided scheme, the style reconstruction loss is then defined as follows:

$${ℒ}_{{sty}_{ref}} = {E}_{{x}_{ref . \hat{x} \_ ref}} [ {‖ S ( {x}_{ref} ) , S ( {\hat{x}}_{ref} ) ‖}_{1} ]$$

In the latent-guided scheme, in addition to encouraging the synthesis network to use the style vector, this style reconstruction loss ensures that the style vectors output by both the mapping network and the style encoder are of the same nature and are therefore interpreted similarly by the synthesis network. The above equation is transposed into:

$${ℒ}_{{sty}_{lat}} = {E}_{{x}_{z , \hat{x} \_ ref}} [ {‖ M ( z ) , S ( {\hat{x}}_{ref} ) ‖}_{1} ]$$

### Diversity Objective:

In order to further enforce diversity in the generated grains, two diversity losses are defined depending on the reference-guided or the latent-guided schemes. In the latter, to force the mapping network M to produce different style vectors given two different latent codes z₁ and z₂, and the synthesis network G to produce corresponding diverse images, the diversity loss is defined to ensure that the cosine similarity between z₁ and z₂ is the same as the one between their respective style vectors sₗₐₜ₁ and sₗₐₜ₂ by computing a ratio as follows:

$${ℒ}_{{div}_{lat}} = {E}_{{z}_{1 ,} {z}_{2}} [ {‖ 1 - \frac{cos ( {s}_{lat 1} , {s}_{lat 2} )}{cos ( {z}_{1} , {z}_{2} ) + ϵ} ‖}_{1} ] ,$$

Since z₁ and z₂, are sampled randomly, ϵ (e.g., ϵ=10⁻⁸) is added to the denominator in case they are equal to prevent a division by zero.

Similarly, to encourage both diversity and fidelity in the reference-guided scheme, another diversity loss is defined to ensure that the cosine similarity between the style vectors s_{ref1} and s_{ref2} of two reference images x_{ref1} and x_{ref2} is the same as the one between the style vectors ŝ_{ref1} and ŝ_{ref2} of their synthesized versions \hat{x}_{ref1} and \hat{x}_{ref2}:

$${ℒ}_{{div}_{ref}} = {E}_{x \_ ref 1 , x \_ ref 2 , \hat{x} \_ ref 1 , \hat{x} \_ ref 2} [ {‖ 1 - \frac{cos ( {\hat{s}}_{ref 1} , {\hat{s}}_{ref 2} )}{cos ( {s}_{ref 1} , {s}_{ref 2} ) + ϵ} ‖}_{1} ]$$

In the proposed diversity loss, one minus the cosine ratio is minimized which converges to 1 in case of two similar style vectors and converge to 0 in case of two different style vectors correctly reproduced by the style encoder.

### Content Preservation Objective:

To preserve the content and to avoid introducing distortions or color shifts, the synthesis network in the reference-guided scheme is further constraint by defining two content preservation losses: an [symbol] pixel-wise loss between x_{ref} and \hat{x}_{ref}, and a feature-wise loss between the last feature maps of x_{ref} and \hat{x}_{ref}, passed through a pre-trained VGG16 network:

$${ℒ}_{1} = {E}_{{x}_{ref} , {\hat{x}}_{ref}} [ {‖ {x}_{ref} - {\hat{x}}_{ref} ‖}_{1} ]$$

$${ℒ}_{VGG} = {E}_{{x}_{ref} , {\hat{x}}_{ref}} [ {‖ VGG ( {x}_{ref} ) - VGG ( {\hat{x}}_{ref} ) ‖}_{2}^{2} ]$$

The proposed methods are frame based. However, they can be easily applied to other media e.g., 360° content, videos. For the latter, a simple frame by frame processing can be first envisioned. Several trainings and subsequently, several networks might be learned depending on different image categories i.e., outdoor images, images with persons, gaming images, UI images, etc., so that the grain style vectors are refined per category.

In another example illustrated by FIG. 13B, the synthesis network outputs the grainy image, which is the addition of the original image and of the generated grain map, and the discriminator takes as input the concatenation of the grain free image and its corresponding grain map (obtained by the difference between the clean image and the grainy one) and compare it to the concatenation of the grain free image and the reference grain map, the reference grain map being computed as the difference between the reference grainy image and the grain free image. The concatenation comprises adding three dimensions to the input channels, for example increasing the number of input channels from 3 (for the grain-free image) to 6 (with the additional channels of the grain map).

In another embodiment, the grain map is not necessarily RGB and could be of dimension 1 (gray). The single-channel map may be added to each channel of the image.

Explicitly decoupling the grain map from the grainy image and giving it to the discriminator allows the discriminator to better classify between real and fake grain maps, thus enhancing its performance.

FIG. 13B thus illustrates a flowchart of a method to jointly learn the neural network parameters according to the above example, in which the discriminator takes as inputs a concatenation of the grain free image and the reference grain map and a concatenation of the grain free image and the synthesized grain map. Compared to FIG. 13A, the same dataset and loss objectives may be used, and the same inputs and outputs may be used for the synthesis, mapping, style encoder networks. Furthermore, the discriminator takes as input a concatenation of the grain free image (x_src) and a predicted grain map computed as (\hat{x}_ref1−x_src), and a concatenation of the grain free image (x_src) and a reference grain map computed as (x_ref1−x_src).

TABLE 4
FID scores for different configurations
of the input of the discriminator

| Discriminator input | Reference | Latent |
|---|---|---|
| Config. 1 | 19.42 | 22.10 |
| Config. 2 | 20.16 | 25.00 |
| Config. 3 | 14.95 | 17.79 |

Table 4 shows the Fréchet inception distance (FID) scores for different input configurations of the discriminator: 1) Config. 1: a grainy image (clean image+grain map), 2) Config.2: a grain map only and 3) Config.3: a concatenation of the clean image and its corresponding grain map. Config 3 improves the quality of the generated grainy images thanks to a better separation of the synthesized grain and the clean image features.

### Reference-Guided Synthesis Qualitative Results

To evaluate the fidelity to the reference grain, different ground-truth grainy images are sampled from the test set, that originate from the same original grain-free content but with different grain styles. The style encoder S is used to extract the style vector from each of these grainy images. The style vectors are then input to the synthesizer network G to add grain again to the original clean image, i.e., grain-free image. The obtained results first show that the synthesized images contain different grain styles, which proves that the style encoder provided the synthesis network with different style vectors. In addition, the outputs are perceptually very close to their corresponding references. This means that both the style encoder and the synthesis network work jointly to produce accurate outputs: the style encoder is able to extract the grain properties regardless of the content and the synthesis network is able to interpret the output style vectors correctly. In addition to the visual comparison, the COSINE similarity may be computed between the style vectors of the different ground-truth and synthesized grainy images. The COSINE similarity score are very high (around 0.9) when the grain styles are close, while low (around 0.3) when the grain styles differ in some or all properties including the spatial distribution, the intensity and the patten.

To verify that the style vector only contains grain characteristics, a style vector is first extracted for a given reference grainy image (from the test set). This style vector is then used to synthesize the grain back again but in different grain-free images. The qualitative comparison of the synthesized images shows that they contain the same grain style. However, the latter was adapted to the content by the synthesizer G. Moreover, when inspecting the grain maps, no content from the grainy image used as reference is present. The style vector, therefore, holds exclusively information on the grain.

A very valuable feature of the proposed style vector is that it contains no content-related information except for the grain style. Thus, when it is compressed and transmitted in a video compression scheme, no redundant information related to the underlying content is transmitted. A style vector of dimension 64 seems to be sufficient enough to encapsulate the desired grain properties, however, its dimension could eventually be reduced.

Other constraints could be added to the style encoder regarding the nature of the style vector in order to facilitate its compression and transmission, for example,
some energy aware constraint, for example related to the size of the style vector and/or some bit rate constraint;
Some robustness constraint to encoding/decoding of the style vector. This can be done by including the encoding/decoding step in the framework and adding a loss ensuring that the style vector is not modified by these two steps;
Some robustness constrained for the synthesized grainy image. Again the encoding/decoding process while training could be added in the whole training framework and the same losses could be used especially in the reference-guided scheme.

The film-grain synthesis method used in the system 8 is compared to a VVC implementation and the deep-based synthesis implementation Deep1 on grainy images selected from the test set. For a fair comparison, the VVC analysis and synthesis methods are performed outside the encoding/decoding steps in the process. In the case of Deep1, as no analysis step is available, all possible different intensity levels were tested and the one closer to the reference was selected for the synthesis.

The results show that VVC is not always able to synthesize the grain in an accurate manner. This could be related to several reasons among which the fact that the analysis is limited to the homogeneous regions only and the limited set of parameters used to represent the grain characteristics. Deep1 outputs are close to the corresponding ground-truths in terms of intensity, which was manually selected to meet the reference intensity. However, the distribution of the grain based on the input content texture is not respected. This might be due to two main reasons: Deep1 is conditioned only by the intensity level of the grain and the grain spatial distribution is learned from another less rich and representative dataset. For a fairer comparison, Deep1 should have been trained on the FilmGrainStyle740k Dataset, which is however not possible as it is conditioned only on the grain intensity level, whereas a set of several parameters defines each grainy image in the new dataset. On the contrary, the film-grain synthesis method used in the systems 7 and 9 provides better visual results and higher fidelity thanks to the joint work of the style encoder and the synthesis network, through the learning of a content-independent grain style which is further adapted to the input content during the synthesis. The quality of the outputs in terms of fidelity results from the use of both the style reconstruction and the diversity losses to constraint the two networks.

Another feature of the style encoder S is that it performs the analysis across the entire input image (homogeneous/textured regions combined) unlike state-of-the-art models that only perform the analysis on homogeneous areas. Under the same idea, the synthesis network is able to generate and blend the grain to a given content according to its texture, saturation, intensity and not only scaling the grain pattern depending on the intensity level of the pixels as it is done in AV1 and VVC.

### Latent-Guided Synthesis Qualitative Results

From a specific grain style, the synthesis network is responsible for adapting this style to the underlying content on some grain-free image while blending it with a generated grain. To demonstrate this feature, one samples a single latent code from Z, map it into a style vector using the mapping network M and uses the resulting style vector to add grain to different images through the use of the synthesis network. The results show that although a same style vector is used, and indeed the grainy images have the same style, they also differ depending on their underlying content, as the grain distribution and look were adapted to it. For example; textured regions contain different grain characteristics than uniform regions, etc. The synthesis network is therefore the module responsible for blending the grain style to the content such that the style vector is content-independent and the synthesis is content-adapted.

In existing approaches, to add and blend grain to a content that did not have any film grain at the first place, a default grain pattern and a default scaling function (not adapted to the given content) are defined and used. Whereas in the system 9 depicted on FIG. 11A, the synthesis network is able to generate and blend the grain in a content-adaptive way based exclusively on a style vector output by the mapping network.

The mapping network M produces diverse grain styles, representative of the content of the dataset. To evaluate the diversity of the grain styles output by the mapping network, one simply samples different latent codes from Z, maps them to style vectors, which are then used by the synthesis network for grain generation.

Resulting images show that the generated grain is different from an image to another. Furthermore, grain diversity is not limited to the intensity level but it also includes diversity in grain patterns, sizes and spatial distributions. The mapping network is therefore capable of generating different style vectors given different latent codes, thanks to the style diversity loss, and without the help of any reference grainy images.

The film-grain synthesis method used in the system 9 is compared with VVC, AV1 and Deep1, in terms of diversity. In the case of Deep1, it is not possible to produce diverse grain patterns, only the intensity could be varied. On the contrary, AV1 and VVC implementations are capable of producing diverse grain styles, by varying the grain pattern's parameters. By varying manually these parameters, different types of grain are obtained. These reported results give some indications of the range of diversity achievable by AV1 and VVC. AV1 and VVC can both produce different grain styles. However, the diversity is limited to the pattern of the grain only, whereas the diversity provided by the proposed method covers several features such as the size, intensity and pattern of the grain. Furthermore, scaling the grain to the underlying content in VVC or AV1 is based only on the content pixel values, whereas film-grain synthesis method used in the system 9 blends and scales the grain based not only on the pixel intensities but also on other low-level and high-level characteristics of the content such as its saturation and the texture. As for Deep1, it is only able to reproduce the single grain pattern it was trained on.

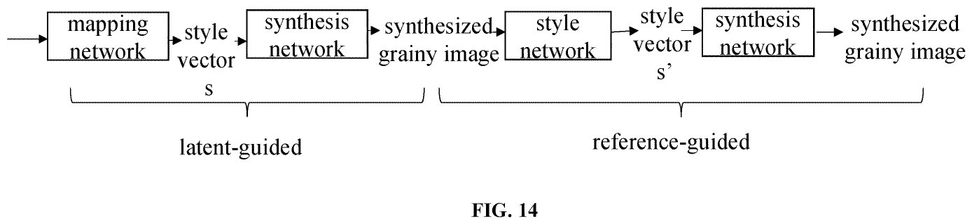

The goal of jointly training the mapping network and the style encoder is to force both networks to produce style vectors that are interpreted in the same manner by the synthesis network. This is illustrated by FIG. 14. A first latent-guided synthesis is operated i.e., from a style vector (originated from a random latent code). From the synthesized grainy image, a new style vector is extracted which is again used in a second step of reference-guided synthesis to generate another synthesized grainy image. Such an experiment represents a complete cycle where all networks M, S and G are used one after another as depicted on FIG. 14 which compares the outputs of both the latent-guided and the reference-guided synthesis. The results show that the outputs of the latent-guided and the reference-guided synthesis are very close perceptually. This means that the mapping network and the style encoder were jointly learned to generate similar style vectors thanks to the style reconstruction losses.

### Quantitative Results

In the reference-guided synthesis, to assess the quality of the synthesized grainy images, two quality metrics PSNR and SSIM are used. Although not well tailored to assess the quality of the output grain, they will assess similarity in terms of underlying content, and ensure that no distortion is added since GANs are known for generating noise.

In the reference-guided synthesis, maximum fidelity to the reference is sought. However, such a fidelity should not be understood at the pixel level, but in terms of grain style. To assess the fidelity to the grain style, the cosine similarity metric is used. It is computed between the respective style vectors as output by the style encoder from a reference image and its synthesized version.

Both in the reference-guided synthesis and the latent-guided one, diversity in the synthesized grainy images is an important feature. The Frechet Inception distance (FID) and learned perceptual image patch similarity (LPIPS) are used to evaluate the latter. FID measures the discrepancy between two sets of images. In the latent-guided scheme, each grain-free image from the test set is first translated into four grainy images using 4 latent vectors randomly sampled from a standard Gaussian distribution. FID is then computed between every pair of (reference-synthesized) images by comparing their feature vectors extracted from the last average pooling layer of Inception-V3 pretrained on ImageNet. LPIPS measures the diversity of the generated images using the LI distance between features extracted from AlexNet pretrained on ImageNet. The average LPIPS distance is first computed between all pairs (6) in each group of 4 latent-guided synthesized grainy images for any test grain-free image. The average distance over all test images is finally reported. FID is computed in a similar manner for the reference-guided scheme, where each clean image is associated with 4 grainy synthesized versions using 4 reference images, instead of 4 latent codes.

TABLE 5
Quantitative comparison on film grain synthesis.

| | Reference-guided | | | | Latent-guided | |
|---|---|---|---|---|---|---|
| | Quality | | Fidelity | Diversity | Diversity | |
| | PSNR | SSIM | COS | FID | LPIPS | FID |
| AV1 [6] | — | — | — | — | 0.012 | 26.25 |
| VVC [7] | 26.66 | 0.709 | 0.971 | 27.94 | 0.168 | 31.04 |
| Deep1 [4] | 24.33 | 0.624 | 0.747 | 30.78 | 0.022 | 26.75 |
| Ours | 26.12 | 0.711 | 0.990 | 18.64 | 0.762 | 18.64 |

Table 5 summarizes the quantitative comparison. For the reference-guided scheme, the proposed method is compared with VVC and Deep1, where VVC is tested while leaving out the encoding/decoding steps. For Deep1, to simulate the analysis step, grainy outputs for all intensity levels were computed and the closest one to the ground truth in terms of quality metrics was kept, thus favoring Deep1 in the comparison. Although based on a GAN, thus likely to introduce distortions, the proposed methods provide comparable quality to VVC solution in terms of PSNR and SSIM. Deep1 reaches lower quality values, as it does not take into account the spatial distribution of the grain, contrary to the proposed method and VVC. In terms of fidelity, the proposed methods outperform all methods, which proves that it was able to correctly extract the grain properties. Deep1 once again achieves the lowest fidelity, although it might be due to its training dataset which contains only one pattern. In terms of diversity, again, the proposed methods outperform the other methods, as the proposed methods is able to reproduce better the diversity present in the dataset. Note that the dataset is built using a software used by artists, which makes it representative of the artistic content. VVC ranks next because of the limited set of parameters it uses to model the grain style, followed by Deep1 which is limited to a single grain pattern.

In the latent-guided scheme, the proposed methods are compared to AV1, VVC and Deep1. For AV1 (resp. VVC), 16 (resp. 7) grainy images are generated, one per set of grain parameters available, for each image in the test set (for VVC, the 7 sets of parameters were manually chosen to maximize the diversity). For Deep1, 5 grainy images are generated for each test image, one per intensity level. Again, the proposed methods outperform all others in terms of quality and diversity. The FID scores show that the diversity of grain styles achieved by the proposed methods are close to the test set's diversity. The VVC high FID value might be due to some odd grain patterns that are sometimes created and which can be considered as distortions.

The above framework (called deep version) uses four modules: a discriminator, a style encoder, a synthesis network and a mapping network. During the learning (a.k.a training) stage, the four modules may be used as depicted on FIG. 13A and FIG. 13 B. During the inference stage, only three modules may be used, e.g., the discriminator is not used at the inference step. In the example deep version, these three modules use a total of roughly 55M parameters as illustrated by Table 6.

TABLE 6
Detailed architectures of the synthesis network, style encoder and mapping network

| Synthesis network G | | | | Style encoder S | | | | Mapping network M | |
|---|---|---|---|---|---|---|---|---|---|
| Layer | Pool | Norm | Output Shape | Layer | Pool | Norm | Output Shape | Layer | Output Shape |
| Conv1 × 1 | — | — | 256 × 256 × 64 | Conv1 × 1 | — | — | 256 × 256 × 64 | Latent z1 × 1 | 16 |
| ResBlk | Avg | IN | 128 × 128 × 128 | ResBlk | Avg | — | 128 × 128 × 128 | Linear(ReLU) | 512 |
| ResBlk | Avg | IN | 64 × 64 × 256 | ResBlk | Avg | — | 64 × 64 × 256 | Linear(ReLU) | 512 |
| ResBlk | Avg | IN | 32 × 32 × 512 | ResBlk | Avg | — | 32 × 32 × 512 | Linear(ReLU) | 512 |
| ResBlk | Avg | IN | 16 × 16 × 512 | ResBlk | Avg | — | 16 × 16 × 512 | Linear(ReLU) | 512 |
| ResBlk | — | IN | 16 × 16 × 512 | ResBlk | Avg | — | 8 × 8 × 512 | Linear(ReLU) | 512 |
| ResBlk | — | IN | 16 × 16 × 512 | ResBlk | Avg | — | 4 × 4 × 512 | Linear(ReLU) | 512 |
| ResBlk | — | IN | 16 × 16× 512 | LReLU | — | — | 4 × 4 × 512 | Linear(ReLU) | 512 |
| ResBlk | — | IN | 16 × 16 × 512 | Conv4 × 4 | — | — | 1 × 1 × 512 | Linear | 64 |
| ResBlk | Up | AdaIN | 32 × 32 × 512 | LReLU | — | — | 1 × 1 × 512 | Parameter # | 1.8M |
| ResBlk | Up | AdaIN | 64 × 64 × 256 | Reshape | — | — | 512 | | |
| ResBlk | Up | AdaIN | 128 × 128 × 128 | Linear | — | — | 64 | | |
| ResBlk | Up | AdaIN | 256 × 256 × 64 | Parameter # | 20M | | | | |
| Conv1 × 1 | — | — | 256 × 256 × 3 | | | | | | |
| Parameter # | 33M | | | | | | | | |

In a video compression context, the style encoder will more probably run at an encoder side which is less constrained in terms of available resources. On the contrary, the mapping and the synthesis networks will probably run at a decoder side, i.e., more likely on resource constrained devices. The current number of parameters of these networks may be an issue for a deployment on any device with low memory, and low processing power since it may result in a high energy consumption and out of memory issue.

A lightweight version of the framework is thus proposed which contains less parameters (e.g., 92% less parameters) than its corresponding deep version, and less flops (e.g., 86% less), while still reaching the same quality in terms of fidelity and the same diversity in terms of film grain styles.

The complexity of the framework is thus reduced, e.g., the energy cost of its training and inference stages is reduced, while maintaining an equivalent performance. In an example, each module/network is simplified independently, e.g. using an ablation study. Each module's performance is then assessed in a framework where the other modules still have their deep architectures, i.e., the architecture mentioned for the deep version and illustrated in Table 6. The result of the simplification is a set of a lightweight synthesis network, a lightweight style encoder and a lightweight mapping network.

The lightweight architecture (referred as Style_NoRes_64) of the style encoder may comprise a 1×1 kernel convolutional layer (#channels_out=8), followed by (e.g., six) convolutional blocks, a Leaky ReLu layer, a 4×4 kernel convolutional layer, another Leaky ReLu and finally a fully connected layer, e.g., of size 8. Each convolutional block comprises an average pooling 2D, a 3×3 kernel convolutional layer, an instance normalization layer and a LeakyRELU. Dimensions of the output channels in the convolutional layers may be equal to 16, 32, 64, 64, 64, 64. The above architecture is an example lightweight architecture of the style encoder.

The lightweight architecture (referred as Synthesis_NoRes_256) of the synthesis network may comprise a first convolutional layer with a kernel 1×1 (#channels out=32), followed by (e.g., four) downsampling blocks, (e.g., four) intermediate blocks, and (e.g., four) upsampling blocks and a last 1×1 kernel convolutional layer. Each downsampling block consists of an instance normalization layer, a LeakyReLU layer, a convolutional layer with a kernel 3×3, and an average pooling 2D. Dimensions of the output channels in these blocks are 64, 128, 256, 256. The intermediate blocks architecture is the same as that of the downsampling blocks but without average pooling. Dimensions of the output channels in these blocks may be 256, 256, 256, 256. Each upsampling block comprises an adaptive instance normalization layer, a LeakyReLU layer, an upsamling layer and a convolutional layer with a kernel 3×3. Dimensions of the output channels in theses blocks may be 256, 128, 64, 32. The above architecture is an example lightweight architecture of the synthesis network.

The lightweight architecture (referred as Mapping_128_4) of the mapping network may comprise a Multi Level Perceptron (MLP) of (e.g., five) fully connected layers (e.g., of dimension 128). The dimensions of the latent code, the hidden layers, and the style code may be set to 16, 128, and 8, respectively. The above architecture is an example lightweight architecture of the mapping network.

A fully end-to-end lightweight version of the framework is thus proposed wherein the three above lightweight architectures may be selected for each module respectively, i.e., Mapping_128_4 as a mapping network, Style_NoRes_64 as a style encoder and Synthesis_NoRes_256 as a synthesis network. Table 7 compares the results obtained by the deep and lightweight versions of the framework, which clearly shows that similar performances can be achieved with a reduction of 92% of the number of parameters and 86% less flops. Compared to the deep version, the proposed fully lightweight framework makes it possible to synthesize grain using less energy (e.g., in terms of memory and processing load), while reaching the same or similar quality performance in terms of fidelity to the original grain and diversity of the generated grain styles.

In the following experiments, the discriminator was chosen to take as input the concatenation of the grain free image (x_src) and a predicted grain map computed as (\hat{x}_ref1−x_src), and a concatenation of the grain free image (x_src) and a reference grain map computed as (x_ref1−x_src).

TABLE 7
Quantitative comparison between the deep and the light versions of the proposed framework

| | Complexity | | Reference guided | | | | Latent-guided | |
|---|---|---|---|---|---|---|---|---|
| Network | #Params ↓ | GFLOPs ↓ | LPIPS ↓ | JSD-NSS ↓ | COSINE ↑ | FID ↓ | LPIPS ↑ | FID ↓ |
| Deep framework (baseline) | 56.65M | 65.31 | 0.090 | 0.0018 | 0.952 | 16.42 | 0.088 | 19.15 |
| Light framework | 4.75M | 9.23 | 0.089 | 0.0012 | 0.941 | 16.29 | 0.088 | 19.67 |

In video compression, the style vector may be extracted at the encoder side, transmitted with the bitstream and then further used at the decoder side to synthesize back the original grain. This implies that the more compact the style vector, the easier it is to encode and transmit it, and the lower the transmission cost. For this reason, the dimension of the style vector may be reduced, e.g., while keeping the same fidelity to the original grain and capability to generate diverse grain styles. To this aim, the fidelity and the diversity of the generated images with different style vector dimensions (32, 16, 8 and 4) is evaluated while maintaining the same lightweight version of the framework described above. A quantitative evaluation of both reference-guided and latent-synthesis synthesis results is reported in Table 8. A comparable performance is obtained with different style vector dimensions on the latent-guided synthesis task. For the quantitative evaluation of the diversity, for each grain-free image, four random latent codes are sampled to generate four grainy versions. The performance evaluation is limited to these four generated versions.

However, in terms of fidelity in the reference-guided synthesis task, a decrease in COSINE similarity scores is observed with smaller style vector sizes, and a jump in LPIPS values with a style vector dimension of 4. Moreover, six different attributes have been used with their values varied to build up the training and test datasets. In an example, the dimension of the style vector may thus be reduced up to 8, which is sufficient to model the properties of the film grain style.

TABLE 8
Quantitative performance of the light framework
for different dimensions of the style vector

| | Reference guided | | | | Latent-guided | |
|---|---|---|---|---|---|---|
| Network | LPIPS ↓ | JSD-NSS ↓ | COSINE↑ | FID ↓ | LPIPS ↑ | FID ↓ |
| 64 | 0.089 | 0.0012 | 0.941 | 16.29 | 0.088 | 19.67 |
| 32 | 0.091 | 0.0013 | 0.950 | 16.54 | 0.097 | 20.01 |
| 16 | 0.088 | 0.0013 | 0.899 | 16.42 | 0.075 | 20.20 |
| 8 | 0.088 | 0.0012 | 0.898 | 16.07 | 0.080 | 19.34 |
| 4 | 0.156 | 0.0012 | 0.845 | 16.18 | 0.083 | 20.06 |

In an example, the style vector dimension is therefore set to 8. Corresponding modifications are done in the output layers of the mapping network and the style encoder and on the input layer of the synthesis network to take this new dimension into account. This style vector of dimension 8 may apply to both versions, i.e., the lightweight and the deep versions. In the following the deep version of the framework may be referred to as baseline.

As indicated above, each module (network) of the lightweight version is obtained independently, e.g. using an ablation study. Said otherwise, each module's performance is assessed in a framework where the other modules have their deep architectures, e.g., the architecture mentioned in Table 6 for the deep version. The results of the ablation study are presented below. The network that gave the best trade-off quality versus complexity for each module is selected to be included in the fully lightweight version of the framework.

In an example, the deep version of the style encoder is replaced by the following lightweight architecture in the complete framework, while keeping the mapping and synthesis networks as in the deep version of the framework: Two different and successive simplifications of the architecture are investigated. First, the dimension of the feature maps (naming StyleEncoder_Res_DimFeatureMaps in Table 9) is reduced. Then, the residual block is replaced with a simple convolutional layer (named StyleEncoder_NoRes_DimFeatureMaps). Table9 summarizes the different tested style encoder networks with their corresponding performances. It appears that comparable scores across the different metrics are achieved with different dimensions of the feature maps. Similar behaviour is observed when replacing the residual blocks with simple convolutional layers. Moreover, replacing a layer of residual blocks with a convolutional layer (StyleEncoder_NoRes_64) reduces significantly the complexity while improving the performance in the latent-guided synthesis task. Reducing the number of parameters by a ratio of 100 and the number of GFLOPs by a ratio of approximately 200, the style encoder still extracts accurately the grain parameters, meaning that the baseline style encoder is overparametrized and that there is still a margin for further reduction.

TABLE 9
Quantitative evaluation of different style encoder architectures.

| | Complexity | | Reference guided | | | | Latent-guided | |
|---|---|---|---|---|---|---|---|---|
| Network | #Params ↓ | GFLOPs ↓ | LPIPS ↓ | JSD-NSS ↓ | COSINE ↑ | FID ↓ | LPIPS ↑ | FID ↓ |
| Style_Res_512 (baseline) | 20.88M | 16.59 | 0.090 | 0.0018 | 0.952 | 16.42 | 0.088 | 19.15 |
| Style_Res_256 | 5.23M | 4.18 | 0.088 | 0.0015 | 0.943 | 16.20 | 0.086 | 19.20 |
| Style_Res_128 | 1.31M | 1.06 | 0.093 | 0.0016 | 0.982 | 16.84 | 0.090 | 19.14 |
| Style_Res_64 | 330K | 0.27 | 0.091 | 0.0015 | 0.984 | 16.54 | 0.091 | 19.27 |
| Style_NoRes_64 | 205K | 0.08 | 0.090 | 0.0019 | 0.978 | 16.43 | 0.102 | 18.98 |

Underlined are the baseline and the chosen simplified network

For the lightweight version of the framework, StyleEncoder_NoRes_64 may be selected as the lightweight version and used since it achieves a good trade-off in terms of performance vs. number of flops.

In an example, the deep version of the synthesis network is replaced by the following lightweight architecture in the complete framework, while keeping the mapping network and the style encoder as in the deep version of the framework: The dimension of the feature maps (Synthesis_Res_DimFeatureMaps) is reduced, before replacing the residual blocks with simple convolutional layers. The network is further simplified by varying similarly the feature maps dimension (Synthesis_NoRes_DimFeatureMaps). Table 10 summarizes the different synthesis networks with their corresponding performance. The worst scores are achieved with feature maps of size 64 (with or without residual blocks). Moreover, with Synthesis_NoRes_64, the COSINE similarity score is close to 1 even if the synthesis is not reliable. This could originate from a dysfunctional style encoder that outputs the same style vector for every input grainy image, resulting in all style vectors to be similar, thus achieving a COSINE similarity score of 1. On the other hand, one could observe relatively low COSINE similarity scores with Synthesis_NoRes_256 compared to the baseline, but better JSD-NSS and LPIPS scores. Hence, it's preferable to not rely only on the similarity of the style vectors when assessing fidelity but also on the similarity of the corresponding synthesized images.

TABLE 10
Quantitative evaluation of different synthesis network architectures.

| | | | Reference guided | | | | | |
|---|---|---|---|---|---|---|---|---|
| | Complexity | | | JSD- | | | Latent-guided | |
| Network | #Params ↓ | GFLOPs ↓ | LPIPS ↓ | NSS ↓ | COSINE ↑ | FID ↓ | LPIPS ↑ | FID ↓ |
| Synthesis_Res_512 | 33.89M | 48.72 | 0.090 | 0.0018 | 0.952 | 16.42 | 0.088 | 19.15 |
| (baseline) | | | | | | | | |
| Synthesis_Res_256 | 8.62M | 12.23 | 0.086 | 0.0009 | 0.969 | 15.91 | 0.059 | 18.51 |
| Synthesis_Res_128 | 2.22M | 3.08 | 0.093 | 0.0018 | 0.928 | 17.01 | 0.059 | 19.55 |
| Synthesis_Res_64 | 594K | 0.78 | 0.100 | 0.0016 | 0.871 | 18.71 | 0.057 | 20.30 |
| Synthesis_NoRes_512 | 17.57M | 36.43 | 0.088 | 0.0018 | 0.892 | 16.29 | 0.074 | 19.78 |
| Synthesis_NoRes_256 | 4.47M | 9.15 | 0.087 | 0.0011 | 0.902 | 15.96 | 0.059 | 19.18 |
| Synthesis_NoRes_128 | 1.15M | 2.31 | 0.094 | 0.0016 | 0.830 | 16.79 | 0.060 | 19.49 |
| Synthesis_NoRes_64 | 310K | 0.59 | 0.126 | 0.0031 | 0.992 | 21.07 | 0.001 | 21.06 |

Underlined are the baseline and the chosen simplified architectures.

Both for the reference-guided and the latent-guided synthesis, the best scores are obtained with feature maps of size 256 (with or without residual blocks). In conclusion, overall performance deteriorates when reducing the dimension of the feature maps, while replacing residual blocks with simple convolutional layers does not seem to impact significantly the performance. Comparison of the reference-guided synthesis from the baseline and the outputs of networks with feature maps of size 256 shows that both light versions of the synthesis network are able to generate a grain map that is close to the reference one. In an example, four randomly chosen latent codes are fed to the mapping network which translates them into four different style vectors, further used by the synthesis network. From this experiment, a fairly good diversity in the outputs of the synthesis network can be observed. For the lightweight version of the framework, Synthesis_NoRes_256 may therefore be used as it achieves a good trade-off in terms of performance vs. number of flops.

In an example, the deep version of the mapping network is replaced by the following lightweight architecture in the complete framework, while keeping the synthesis network and the style encoder as in the deep version of the framework: The number of nodes per fully connected layer is reduced which does not change the overall architecture of the model but reduces drastically the networks complexity. In a second step, the number of layers is also reduced. Table 11 summarizes the different mapping network variations tested (Mapping_NbNodes_NbLayers) and their corresponding performance. First, the performance of the framework does not seem to be impacted on the reference-guided synthesis task when varying the mapping network architectures. Second, quite similar scores are achieved by all the network on the latent-guided synthesis with best performance achieved by Mapping_256_5 and Mapping_128_4. This tends to confirm that not all of the nodes were useful, most of them were either redundant or did not contribute much, in the deep architecture. Results shows that reducing the number of nodes/layers does not strongly impact the diversity. This light version achieves a good trade-off in terms of diversity/quality vs. complexity and is selected to build the end-to-end light framework.

TABLE 11
Quantitative evaluation of different mapping network architectures.

| | | | Reference guided | | | | | |
|---|---|---|---|---|---|---|---|---|
| | Complexity | | | JSD- | | | Latent-guided | |
| Network | #Params ↓ | MFLOPs ↓ | LPIPS ↓ | NSS ↓ | COSINE ↑ | FID ↓ | LPIPS ↑ | FID ↓ |
| Mapping_512_7 | 1.88M | 1.88 | 0.090 | 0.0018 | 0.952 | 16.42 | 0.088 | 19.15 |
| (baseline) | | | | | | | | |
| Mapping_256_7 | 480K | 0.48 | 0.090 | 0.0015 | 0.969 | 16.27 | 0.116 | 19.32 |
| Mapping_128_7 | 126K | 0.12 | 0.093 | 0.0015 | 0.949 | 16.78 | 0.115 | 19.95 |
| Mapping_256_6 | 415K | 0.41 | 0.089 | 0.0016 | 0.964 | 16.20 | 0.096 | 19.05 |
| Mapping_256_5 | 349K | 0.35 | 0.088 | 0.0015 | 0.947 | 16.22 | 0.097 | 18.84 |
| Mapping_256_4 | 283K | 0.28 | 0.089 | 0.0014 | 0.966 | 16.14 | 0.125 | 19.66 |
| Mapping_256_3 | 218K | 0.22 | 0.090 | 0.0016 | 0.958 | 16.10 | 0.123 | 20.49 |
| Mapping_128_6 | 109K | 0.11 | 0.091 | 0.0015 | 0.973 | 16.40 | 0.127 | 19.42 |
| Mapping_128_5 | 92K | 0.09 | 0.089 | 0.0016 | 0.966 | 16.29 | 0.106 | 20.11 |
| Mapping_128_4 | 76K | 0.07 | 0.089 | 0.0012 | 0.971 | 16.27 | 0.104 | 19.48 |
| Mapping_128_3 | 59K | 0.06 | 0.091 | 0.0015 | 0.958 | 16.76 | 0.118 | 19.81 |

Underlined are the baseline and the chosen simplified architectures.

For the light version of the framework, Mapping_128_4 may therefore be used as it achieves a good trade-off in terms of performance vs. number of flops.

The present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, obtaining a film grain style vector, reconstructing a grainy image from a film grain style vector.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, obtaining a film grain style vector, reconstructing a grainy image from a film grain style vector.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS (Sequence Parameter Set), a PPS (Picture Parameter Set), a NAL unit (Network Abstraction Layer), a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of film grain parameters, e.g. a style vector. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

A method is disclosed that comprises:
obtaining an image; and
obtaining a film grain style vector representative of characteristics of film grain contained in the obtained image by using a first neural network(S) with the obtained image as input, the first neural network being a network trained to output a film grain style vector from an image.

A method is disclosed that comprises:
obtaining an image and a film grain style vector, the film grain style vector being representative of characteristics of film grain; and
reconstructing a grainy image by using a second neural network (G) with the obtained image and the obtained film grain style vector as inputs, the second neural network being a network trained to output a grainy image from a film grain style vector and an image.

A method is disclosed that comprises:
obtaining an image;
obtaining a film grain style vector representative of characteristics of a film grain by using a third neural network with a latent code as input, the third neural network being a network trained to output a film grain style vector from a latent code;
reconstructing a grainy image by using a fourth neural network on the received image and the film grain style vector, the fourth neural network being a network trained to output a grainy image from a film grain style vector and an image.

In an example, the second and the fourth neural networks are one and the same neural network and the method comprises learning jointly the first neural network, the second neural network, optionally the third neural network, using a discriminator neural network from a dataset comprising N different grain free images and, for each of the N grain free images, M grainy versions, N and M being integers.

In an example, N=148694 and M=5.

In an example, learning jointly the first neural network, the second neural network, optionally the third neural network, using a discriminator neural network comprises, for a triplet of a grain free image, a first grainy version and a second grainy version of the grain free image: a first forward pass comprising using the first neural network with the first grainy version as input to output a first film grain style vector and with the second grainy version as input to output a second film grain style vector, using the second neural network with the grain free image and the first film grain style vector as inputs to output a first grainy image and with the grain free image and the second film grain style vector as inputs to output a second grainy image, using the discriminator neural network with the first grainy version as input and with the first grainy image as input, using the first neural network with the first grainy image as input to output a third film grain style vector and with the second grainy image as input to output a fourth film grain style vector; and deriving a first global loss function from the outputs;
a first backward pass to update at least one neural network among the first neural network, the second neural network and the discriminator neural network by backward propagating the first global loss function.

In an example, learning jointly the first neural network, the second neural network, the third neural network using a discriminator neural network further comprises, for a triplet of a grain free image, a first grainy version and a second grainy version of the grain free image: a second forward pass comprising using the third neural network with a first latent code as input to output a fifth film grain style vector and with a second latent code as input to output a sixth film grain style vector, the first and second latent codes being sampled randomly, using the second neural network with the grain free image and the fifth film grain style vector as inputs to output a third grainy image and with the grain free image and the sixth film grain style vector as inputs to output a fourth grainy image, using the discriminator neural network with the first grainy version as input and with the third grainy image as input, using the first neural network with the third grainy image as input to output a seventh film grain style vector and with the fourth grainy image as input to output an eighth film grain style vector; and deriving a second global loss function from the outputs;
a second backward pass to update the first neural network, the second neural network, the third neural network and the discriminator neural network by backward propagating the second global loss function.

In an example, the first forward and backward passes followed by the second forward and backward passes are repeated with a new triplet until all possible triplets in the dataset are used. In an example, the first global loss function is a sum of elementary first loss functions, at least one first elementary loss function being defined to ensure that the cosine similarity between the first and second film grain style vectors is close to the cosine similarity between the third and fourth film grain style vectors.

In an example, at least one second elementary loss function is defined to ensure that the first grainy image is close to the first grainy version.

In an example, the second global loss function is a sum of elementary second loss functions comprising at least one elementary second loss function defined to ensure that the cosine similarity between the first and second latent codes is close to the cosine similarity between the fifth and sixth film grain style vectors.

The style network (or style encoder) S configured to output a film grain style vector from an input image enables film grain analysis and modeling given exclusively the grainy image (no prior filtering needed), enables film grain analysis in the entire input image (not only in homogeneous regions), enables strong fidelity to some grainy reference image thanks to the high modeling capacity of the deep learning model, enables a rich yet compact and easy-to-transmit representation of the grain characteristics, enables a content independent style representation (thus when transmitted no redundant information from the content is transmitted again).

The mapping network M configured to output a film grain style vector from a latent code enables providing style vectors when no reference is available, enables diversity of the output grain styles, enables an output style vector compatible with the style vector output by the style encoder.

The synthesis network G is configured to generate a grain style according to some input style vector and blending it to a given input image in a content-adaptive manner.

The joint learning of the above networks outperforms the existing performances of grain analysis and synthesis, especially in the compression chain, does not require any prefiltering or edge detection steps.

The proposed loss functions used in the joint learning ensure fidelity and diversity of the grain styles. Film grain analysis not conditioned from a grain map as it takes directly as input the grainy image.

1. A method comprising:
obtaining an image; and
obtaining a film grain style vector representative of characteristics of film grain contained in the obtained image by using a first neural network with the obtained image as input, the first neural network being a network trained to output a film grain style vector from an image.

2. The method of claim 1, comprising:
obtaining another image; and
reconstructing a grainy image by using a second neural network with the another image and the obtained film grain style vector as inputs, the second neural network being a network trained to output a grainy image from a film grain style vector and an image.

3. A method comprising:
obtaining an image and a film grain style vector, the film grain style vector being representative of characteristics of film grain; and
reconstructing a grainy image by using a second neural network with the obtained image and the obtained film grain style vector as inputs, the second neural network being a network trained to output a grainy image from a film grain style vector and an image.

4. A method comprising:
obtaining an image;
obtaining a film grain style vector representative of characteristics of a film grain by using a third neural network with a latent code as input, the third neural network being a network trained to output a film grain style vector from a latent code; and
reconstructing a grainy image by using a second neural network on the obtained image and the film grain style vector, the second neural network being a network trained to output a grainy image from a film grain style vector and an image.

5. A method comprising learning jointly a first neural network, a second neural network using a discriminator neural network from a dataset comprising N different grain free images and, for each of the N grain free images, M grainy versions of each grain free image, N and M being integers, said first neural network being a network trained to output a film grain style vector from an image and said second neural network being a network trained to output a grainy image from a film grain style vector and an image.

6. The method of claim 5, wherein N=148694 and M=5.

7. The method of any one of claims 5 to 6, wherein learning jointly the first neural network, the second neural network using a discriminator neural network comprises, for a triplet of a grain free image, a first grainy version and a second grainy version of the grain free image:
a first forward pass comprising using the first neural network with the first grainy version as input to output a first film grain style vector and with the second grainy version as input to output a second film grain style vector, using the second neural network with the grain free image and the first film grain style vector as inputs to output a first grainy image and with the grain free image and the second film grain style vector as inputs to output a second grainy image, using the discriminator neural network with the first grainy version and with the first grainy image as inputs or using the discriminator neural network with a first concatenation of the grain free image and a predicted grain map and a second concatenation of the grain free image and a reference grain map as inputs wherein the predicted grain map is computed as a difference between the first grainy image and the grain free image and wherein the reference grain map is computed as a difference between the first grainy version and the grain free image, using the first neural network with the first grainy image as input to output a third film grain style vector and with the second grainy image as input to output a fourth film grain style vector; and deriving a first global loss function from the outputs; and
a first backward pass to update at least one neural network among the first neural network, the second neural network and the discriminator neural network by backward propagating the first global loss function.

8. The method of claim 7, wherein learning jointly a first neural network, a second neural network using a discriminator neural network comprises learning jointly a first neural network, a second neural network and a third neural network using a discriminator neural network, the third neural network being a network trained to output a film grain style vector from a latent code.

9. The method of claim 8, wherein learning jointly the first neural network, the second neural network, the third neural network using a discriminator neural network further comprises:
a second forward pass comprising using the third neural network with a first latent code as input to output a fifth film grain style vector and with a second latent code as input to output a sixth film grain style vector, the first and second latent codes being sampled randomly, using the second neural network with the grain free image and the fifth film grain style vector as inputs to output a third grainy image and with the grain free image and the sixth film grain style vector as inputs to output a fourth grainy image, using the discriminator neural network with the first grainy version and with the third grainy image as inputs or using the discriminator neural network with a first concatenation of the grain free image and a predicted grain map and a second concatenation of the grain free image and a reference grain map as inputs wherein the predicted grain map is computed as a difference between the first grainy image and the grain free image and wherein the reference grain map is computed as a difference between the first grainy version and the grain free image, using the first neural network with the third grainy image as input to output a seventh film grain style vector and with the fourth grainy image as input to output an eighth film grain style vector; and deriving a second global loss function from the outputs; and
a second backward pass to update at least one neural network among the first neural network, the second neural network, the third neural network- and the discriminator neural network by backward propagating the second global loss function.

10. The method of claim 9, wherein the first forward and backward passes followed by the second forward and backward passes are repeated with a new set of values.

11. The method of claim 7, wherein the first global loss function is a sum of elementary first loss functions, at least one first elementary loss function being defined to ensure that a cosine similarity between the first and second film grain style vectors (s_ref1, s_ref2) is close to the cosine similarity between the third and fourth film grain style vectors (ŝ_ref1, ŝ_ref2).

12. The method of claim 11, wherein at least another one first elementary loss function being defined to ensure that the first grainy image is close to the first grainy version.

13. The method of claim 9, wherein the second global loss function is a sum of elementary second loss functions comprising at least one elementary second loss function defined to ensure that a cosine similarity between the first and second latent codes is close to the cosine similarity between the fifth and sixth film grain style vectors.

14-18. (canceled)
